(19) United States
(12) Patent Application Publication
(10) Pub. No.: US 2004/0236450 A1
(43) Pub. Date: Nov. 25, 2004

(54) Model-based machine diagnostics and prognostics using theory of noise and communications

(75) Inventors: Michael D. Bryant, Austin, TX (US); Jongbaeg Kim, Albany, CA (US); Sanghoon Lee, Austin, TX (US); Ji-Hoon Choi, Austin, TX (US)

Correspondence Address: Hulsey, Calkins, Fortkort & Webster, LLP, 8911 North Capital of Texas Highway, Suite 3200, Austin, TX, 78759, US

(73) Assignee: Motorwiz, Inc.

(21) Appl. No.: 09/962,633

(22) Filed: Sep. 25, 2001

Related U.S. Application Data
(60) Provisional application No. 60/235,251, filed on Sep. 25, 2000.

(51) Int. Cl. G06F 19/00

(52) U.S. Cl. 700/108

(57) ABSTRACT

The invention is directed to a method for diagnosing the state of a system. The system may be mechanical, chemical, electrical, medical, industrial, business operations, manufacturing related, and/or processing related, among others. The method may measure a signal from the system. Further, the method may compare the signal to an expected signal. The method may calculate a signal strength and/or a noise. The signal strength and noise may be functions of a frequency. Further, the signal strength and noise may be used to determine a channel capacity and/or a rate of information. A comparison of the rate of information and the channel capacity may yield information associated with the state of the system. The information may be used in diagnosing the state of the system. Further, the expected signal may be derived from a model. The model may be tuned to the measured signal. The model may have parameters that are associated with features and/or faults of the system. These parameters may be used in diagnosing the state of the system. Further, selectively repeated diagnosis over time may yield a prognosis of the system.

### RELATED APPLICATIONS

This application claims priority of U.S. patent Application Ser. No. 60/235,251, filed Sep. 25, 2001 entitled: “MODEL-BASED MACHINE DIAGNOSTICS AND PROGNOSTICS USING THEORY OF NOISE AND COMMUNICATIONS”, and is incorporated herein by reference in its entirety.

### BACKGROUND OF THE INVENTION

1. Field of the Invention

The present invention generally relates to a method of diagnosing systems. In particular, the present invention relates to a model-based method for diagnosing the operational health of a system, and for forecasting the future operational health of the system.

2. Description of Prior Art

Diagnostics and prognostics are used in many fields. These fields may include mechanical, chemical, electrical, medical, manufacturing, processing, and business operations, among others. Each of these fields has problems and difficulties relating to determining the source of a problem, identifying the severity of the problem, and predicting the behavior of a system in relation to the problem.

For example, reliability and maintenance of complex equipment is critical to productivity and product quality. The purchase price of many typical equipments may account for half the equipments' cost. Maintenance and support during the “life-cycle” may consume an amount roughly equal to the book value of the asset.

For example, at a typical chip plant, billions of dollars are invested in equipment; many traditional manufacturing plants invest hundreds of millions of dollars in manufacturing machinery. Most maintenance is rigidly scheduled by “time in service”, not condition. Machine productivity is lost during maintenance downtime. This and unscheduled downtime due to failures represent a very large part of a machine user's cost of operation.

In these embodiments, machines are complex systems of components: gears, shafts, bearings, motors, lead screws, sensors, electronics, microprocessors, etc. integrated into a working whole. Machines in this context can also be biological, chemical, or hydraulic, among others. Defective or degraded components, alone or interacting, can render a machine dysfunctional. The machine may fail catastrophically and not complete its task, or it may lose tolerance, resulting in defective parts. Although methods and models exist for many individual component failures, errors from slightly degraded components can “stack”, yielding overall system failure even when these models predict health of all individual components.

Many typical designers of machinery and engineers that maintain machinery, essentially know what the potential system faults are, and at what locations in the machine these faults will occur. However, unexpected breakdowns will still occur. Many typical designers and engineers do not know and/or can only poorly predict when faults will occur. Further, periodically, healthy machinery must be taken out of service for maintenance. Thus adding an unnecessary cost. Also, it may be very difficult and sometimes impossible to observe many of the conditions internal to the machine that lead to failure.

One can easily imagine metaphoric extensions of these problems to other fields such as chemical, electrical, medical, manufacturing, processing, and business operations, among others. As such, many typical systems suffer from deficiencies in providing accurate diagnostics and prognostics. Many other problems and disadvantages of the prior art will become apparent to one skilled in the art after comparing such prior art with the present invention as described herein.

### SUMMARY OF THE INVENTION

Aspects of the invention are found in a method to diagnose operational health of a system, and to forecast future health. For example, the method may permit intelligent scheduling of maintenance downtime in a mechanical or chemical system. Further, the method may be used, for example, to avoid functional and catastrophic failures.

Further aspect of the invention may be found in the method assembling models of the machine system, including system components and known system faults. Faults may be treated as “noise”. In addition, parameters in the model may be “tuned” from signals from the real system, causing the model to mimic the real system in its present condition. Diagnosis may then be performed by observing the model.

In another aspect of the invention, the method may treat the system as a communications channel, estimate signal and noise levels, and diagnose health of the system with a tuned model by assessing how much information per unit time the system in its present condition can convey over its communications channel. The method may compare this maximum amount to the amount required by the system to execute a certain task. The method may assess if a system, in a given state, can perform a certain function, with a specified performance, within a given tolerance.

Other aspects of the invention may be found in a method based on fundamental principles of physics and information theory. Further aspects may be found in the method assessing functional condition or state operable to perform a specified task, in addition to potential for catastrophic failure. Additionally, the method may operate on a tuned model, avoiding interpretation of complicated signals. Furthermore, the method may allow predictive scenarios for a system's possible future health and functional condition, given certain observed trends.

In another aspect, for a different system or a new system design, only the model may be altered and not the basic diagnostic algorithm. The method may also permit the incorporation of knowledge of faults, and the intent of the designers of systems, into the diagnostics routines.

Another aspect of the invention may be found in assembling detailed dynamic systems models of the system in question. The models may posses a one to one correspondence between at least a portion of the physical components or elements in the real physical system, and elements in the dynamic systems model. In some embodiments, all of the physical components are modeled in a one to one correspondence.

In one embodiment the model may include all possible faults and potential failures in the system models. These effects may be tabulated as “noise” in the system. Noise in a signal is the difference between the actual signal and the expected signal. In the model, noise may be induced by changes in parameters of dynamic system elements, which then alters any signals passing through a system. Alternatively, if a certain fault cannot be described by these means, then sources of noise may be inserted into the system model, at locations in the model that are consistent with the locations of the faults in the real system. The intensity of these noise sources may be adjusted to make the model behave like the real system.

In an exemplary embodiment, the method may further include, placing sensors on a machine, to monitor the machine; exciting the machine; and observing the machine's response via the sensor outputs. The collected data may be used to tune the model's parameters, so the model mimics the real system. After data has been collected on the actual machine, the system model may be excited with the same excitation as the actual machine. The outputs of the model maybe compared to the corresponding outputs of the real machine. If the model's outputs differ from the real machine's outputs, the values of model parameters may be adjusted or changed, including the intensity of the noise sources, until the model's outputs approximate the actual system's outputs.

In one embodiment, the channel capacity, C, of the system may be calculated. The channel capacity may be the maximum amount of information per unit time that can be measured from successfully conveyed through the machine. The channel capacity may depend on the design and construction of the system, and the present condition of the system, which results from aspects. These aspects may include manufacturing, aging and damage, among others. For example, faults may be encoded as “noise” in the model. Analytically, the channel capacity may depend on the strength of the noise levels in the system, relative to the strength of the excitation system response signal.

In the exemplary embodiment, for a desired task to be performed by the machine, the rate of information associated with the task may be calculated. The rate of information may depend on the desired speed at which the machine does the task, the desired loads imposed on the machine, the complexity of the task, and the desired accuracy at which the machine should do the task. Further, the rate of information may be measured.

Another aspect of the invention may be found in comparison of the rate of information to the channel capacity. This comparison may be used to evaluate the operability of the system. If the rate of information is less than or equal to the channel capacity, the system may perform the desired task within the desired precision. If the rate of information is greater than the channel capacity, the system may functionally fail.

Another aspect of the invention may be found in the formulation of extremely detailed models of the system to describe a system's condition. In one exemplary embodiment of a system, the model includes bond graph based models of a motor, a gear box, and other mechanical transmission components. These extremely detailed models (a) exhibit a one to one correspondence between elements in the model and components in the real system; (b) incorporate many typical effects of the device into the model, including defects; (c) include in the models, via finite element concepts instilled into bond graphs, the dynamically distributed nature of components in the real system, and (d) use noise sources to account for defects and degradation of components. Simulation of the motor and gear box models may generate the complex spectra measured during operation of these devices. These models may mimic real system behavior and may be used to store information regarding the health condition of the machine.

In a further aspect, the models tabulate the effects of system faults (system maladies) as “noise” in the machine. Noise may be the difference between the actual signal received, and the expected signal that should be received. As a machine degrades or ages, the difference between actual and expected signals may become larger. Thus noise levels may increase. These noise methods permit incorporation of faults into the models that heretofore could not be described analytically. The herein described methods have imported this body of knowledge to mechanical, hydraulic, other physical systems, and others, to name a few.

In an additionally aspect, the method may be used to predict the future conditions of systems, for scheduling maintenance and avoiding functional and catastrophic failures of the systems. The method may forecast if a complex system is capable of performing a given task, at a given speed and load, within a specified tolerance.

The model system may be implemented on a computer system. Hardware and software components may in combination allow the execution of computer programs associated with the method. The computer programs may be implemented in software, hardware, or a combination of software and hardware.

Further modifications and alternative embodiments of various aspects of the invention will be apparent to those skilled in the art in view of this description. Accordingly, this description is to be construed as illustrative only and is for the purpose of teaching those skilled

As such, a method for diagnosing and prognosticating the state of a system is described. Other aspects, advantages and novel features of the present invention will become apparent from the detailed description of the invention when considered in conjunction with the accompanying drawings.

### BRIEF DESCRIPTION OF THE DRAWINGS

FIG. 1 is a schematic block diagram depicting the Shannon-Weaver Model for use according to the invention.

FIG. 2 is a schematic block diagram depicting the information path according to the invention.

FIG. 3 is a schematic block diagram depicting a series of information paths according to the invention.

FIG. 4 is a block schematic diagram depicting a computation system for implementing the method, according to the invention.

FIG. 5 is a schematic block diagram depicting a network system for implementation of the method, according to the invention.

FIG. 6 is a block flow diagram depicting an exemplary method according to the invention.

FIG. 7 is a cross sectional view of squirrel cage induction motor.

FIG. 8 depicts Ghosh and Bhadra's [5] bond graph of a squirrel cage induction motor.

FIG. 9 depicts the stator resistances in FIG. 8 redistributed to each of the stator coils.

FIG. 10 depicts a simplified representation of the signal and modulated GY element.

FIG. 11 depicts a squirrel cage rotor with five bars.

FIG. 12 depicts a transformation of α and β phase currents into rotor bar currents.

FIG. 13 depicts the bond graph structure including stator and rotor bar action.

FIG. 14 depicts the bond graph equivalence used in modeling.

FIG. 15 depicts the bond graph representing stator and rotor bar action in the magnetic circuit.

FIG. 16 depicts angular velocity of rotor axis and stator currents in stator winding.

FIG. 17 depicts angular velocity of rotor axis and stator currents in stator windings, at startup.

FIG. 18 depicts angular velocity of rotor axis and 5-currents in each rotor bar, at startup.

FIG. 19 depicts angular velocity of rotor axis and 5-currents in each rotor bar, at startup.

FIG. 20 depicts angular velocity of rotor axis and 5-currents in each rotor bar, from startup to steady state.

FIG. 21 depicts stator currents and rotor velocity of a machine with a broken rotor bar.

FIG. 22 depicts stator current of 2nd phase and rotor velocity of a healthy machine at steady state.

FIG. 23 depicts stator current of 2nd phase and rotor velocity of a machine with a broken rotor bar at steady state.

FIG. 24 depicts the angular velocity of rotor axis and 5 currents in each rotor bar when the 3*d bar is broken.

FIG. 25 depicts a torque-time plot of healthy machine and one rotor bar-broken machine.

FIG. 26 depicts rotor velocities of healthy and shorted machines.

FIG. 27 depicts rotor torques of healthy and shorted machines.

FIG. 28 depicts rotor bar currents of shorted machine.

FIG. 29 depicts Kim and Bryant's bond graph of an induction motor with state variables.

FIG. 30 depicts angular position and velocity of rotor axis.

FIG. 31 depicts flux in rotor α windings; the β winding flux is similar.

FIG. 32 depicts flux in stator α windings; the β winding flux is similar.

FIG. 33 depicts rotor velocity of a machine with a broken rotor bar.

FIG. 34 depicts stator current in the Frequency domain with broken bars.

FIG. 35 depicts torque-speed characteristics of the ideal and degraded machines.

FIG. 36 depicts power spectrum of the machine response and noise.

FIG. 37 depicts noise in the signal of the angular velocity of the degraded machine.

FIG. 38 depicts channel capacities with a broken bar.

FIG. 39 depicts rotor velocity of ideal and shorted machines.

FIG. 40 depicts power spectrum of angular velocity for the shorted machine.

FIG. 41 depicts spectral content of stator current of phase A; (a) Ideal machine. (b) Shorted machine. (c) Ideal machine of [15]. (d) Shorted machine of [15]

FIG. 42 depicts spectral content of stator current of phase A with two severely shorted coils. (Rₛ₁=Rₛ₂=0.0079 Ω, nₛ₁=nₛ₂=10)

FIG. 43 depicts channel capacities with one shorted coil.

FIG. 44 depicts channel capacities with two shorted coils.

### DETAILED DESCRIPTION OF THE PREFERRED EMBODIMENT

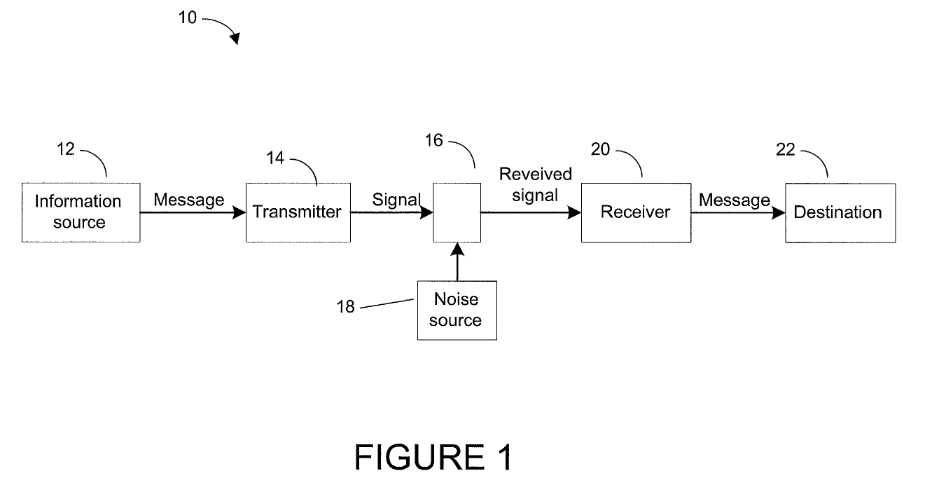

Claude Shannon formulated a mathematical theory of communication. His groundbreaking approach introduced a simple abstraction, the communication channel consisting of a sender (a source of information), a transmission medium (with noise and distortion), and a receiver (whose goal is to reconstruct the sender's messages), see FIG. 1.

The transmitter injects messages from an information source into the channel. The receiver accepts a signal from the channel that contains the transmitted signal altered by the dynamics of the channel, and corrupted by noise added by the channel.

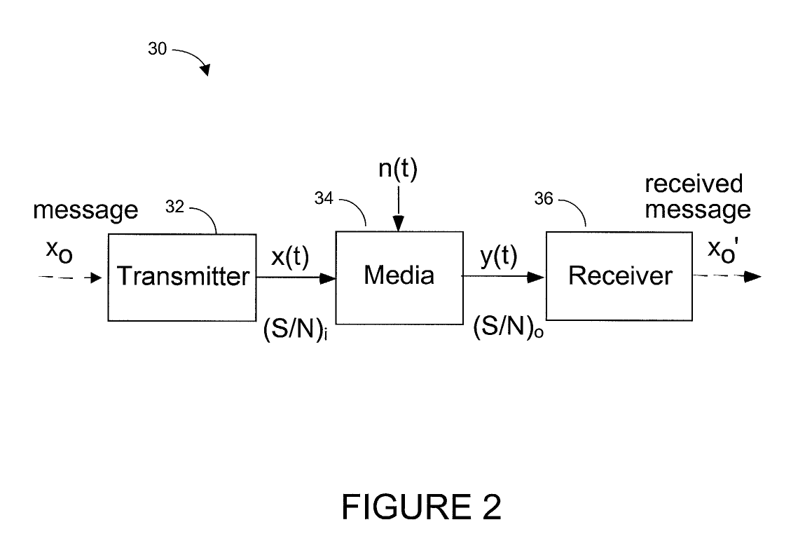

An analogy is made between a machine component or a system and a communications channel. During operation, information is sent as a signal over a communications channel from transmitter to receiver (See FIG. 2). The signal over the channel is altered by limited dynamic bandwidth, nonlinearities and noise. The goal is for the receiver to extract and reproduce the message, despite distortions and noise. Design of communications systems is aided by powerful theorems of Shannon (1949), which establish minimum signal to noise ratios for error free transmission.

A machine component (or system) accepts a “signal” from an upstream component, by its function alters that signal, and then passes the “signal” on to the next downstream component. In the analogy of this article, a machine is a communications channel. When operating properly, the “signal” from an upstream component is “received” by a downstream component. Faults in the machine that disrupt functionality alter the “signal”. Faults will be viewed as agents that alter system parameters or contaminate the signal with “noise”. Unless the signal to noise ratio is kept sufficiently high, downstream components cannot “resolve” the “signal message” error free, and the machine malfunctions.

In performing a function, a machine, component, or system accepts a stimulus “signal” from another upstream component, alters that signal via its mechanical function, and then passes the signal on to the next component. The signal contains information, which can be envisioned as a “message” to other components in the machine. The “message” relates to the function or intended operation of the machine or machine components. The mechanical function often includes kinematics of motion and dynamics of operation.

Here we will strike an analogy between a machine component and a communications channel. The transmitter, an upstream component, activates our machine component “channel” with input signal x(t). Passage of the “signal” through the channel is associated with component functionality: component kinematics and dynamics alter the signal. The component response defines the output y(t). When the component channel operates properly, the “message” contained in the signal “received” by downstream components can be unambiguously “resolved”. Defects and degradation of the component afflict normal operation, “distorting” the signal and contaminating it with “noise” n(t). Unlike electromagnetic communication channels, the signal may pass through multiple power domains: electrical, mechanical, solid, fluid, chemical, biological, etc. along its path through a component or a machine system. We can view a machine as a channel consisting of individual component channels connected together to form a larger channel.

The theory depicted and described in this application may be adapted in unique ways not contemplated by others, including, but not limited to, Shannon's theory. A component is designed to have functionality, which can be defined in terms of the (designer's) intended reaction of the component to an excitation. Degradation alters the component response. For example, fretting corrosion of the surface of an electrical contact changes the electrical impedance through the contact. Although this alters the response to a voltage stimulus, the resulting signal distortions caused by changes of the electric contact impedance are often posed in terms of an effective noise riding on the transmitted signal. Thus degradation of the contact via fretting is often modeled as an effective noise source and/or an impedance change.

In communications theory, Shannon's theorems traditionally estimate the maximum rate of information C that can be transmitted through a communications channel, given its bandwidth w and ratio of signal to noise powers S/N. Designers of traditional communications channels considered C to be fixed, and their designefforts focused on designing transmission or encoding schemes that would increase the rate of information R up to its upper limit, the channel capacity C. If applied in a nontraditional manner to machinery, Shannon's theorems can yield a threshold signal to noise ratio (S/N)ₜ. In the communications channel analogy, dynamics inherent in the component functionality can be included in bandwidth w and in the signal to noise ratio S/N of the channel capacity C. These dynamics may change as the component degrades, causing C to change. For a typical machine and components, signal transmission rateR should be constant, since machine or component operation is often repetitive (or periodic) and at or near steady state: the machine controller and/or upstream components continue to inject their signals into a machine (or component), regardless of its condition.

When applying communications theory to a machine component or system, we will first trace the path of signal power flowing through a healthy (functional) component or machine, to define the communications channel through the component or machine. Along the signal path we will list the various forms of energy or power into which the signal is transformed. Functionality will be defined in terms of the input to output response, for components or the system: if for a given set of input excitations, the output response matches within some tolerance the desired output, the component or the system is functional; otherwise it is dysfunctional. If needed, we will consider each separate energy/power domain and its transduction as a communications channel, and then connect these channels together in a manner consistent with the machine's functionality and design. Bond graphs (Karnopp, Margolis, and Rosenberg, 1990), which map power flows through dynamic systems, can be useful, since bond graphs readily handle systems with diverse energy domains in an energetically consistent manner.

After analyzing the healthy system, we will then incorporate component faults and degradation modes into the system model. To affect functionality, the degradation effects must alter or block the flow of signal power through the component. Questions we must answer include: How does each degradation mode alter the signal flow, and affect system or component parameters? Does the particular degradation cause components to become nonlinear? Does the particular degradation generate another signal, i.e., noise? We will incorporate degradation into the system model as changes to existing system model parameters or as additional elements (e.g., sources of noise). Location of each degradation mode in the system model will be consistent with the locus of the degradation in the physical machine component or system.

Aspects of this method include: 1) Individual components, or an entire machine system consisting of multiple components, can be analyzed. 2) System malfunctions can be predicted, including individual faults and those due to a collection of seemingly healthy components. Errors from slightly degraded but individually healthy components can stack through a machine system, rendering it unable to meet tolerance. 3) The current status of the system, and time to system malfunction can be estimated by simulations based on these models.

Other aspects of the diagnostic procedure include: Determine and trace the path of the signal flow through the healthy system, from signal in to signal out. For the sick system, model the faults with noise sources or parameter changes. Multiple system outputs may exist. At each output, tally the signal power and the total noise power to obtain a signal to noise ratio S/N. Estimate the bandwidth w for the signal path through the degraded component communications channel, using the enhanced system model. Apply Shannon's theorems to diagnose the absolute health of the machine component or machine system.

The health of each individual component in a machine system can be assessed, and likewise the health of the entire machine system. The analysis of each machine component communications channel may contain the following:

Healthy Machine Model which has no faults and functions perfectly. This is an idealization that reflects the machine designer's original intended concept. The output yₒ(t) of a signal x(t) propagating through this ideal machine will define the intended message or signal yₒ(t) that the machine component or machine system communications channel is supposed to transmit and receive. The signal powers S=P{y}and Si=P{yₒ} defined by

$$S = P \{ y \} = \frac{1}{T} {\int }_{0}^{T} {[ y ( t ) ]}^{2} ⅆ t , \qquad eqn ( 1 )$$

both in the channel capacity C and the rate of information transmission R through the channel, will be based on this ideal machine. The resulting model is simple, the concept of perfect health is well defined, and the signal yₒ(t) that the receiver is supposed to receive is well defined.

Machine Faults: These include common degradation faults for a given component. Common examples include pitting of gear teeth, fatigue cracking of shafts, and deterioration of insulation on electric motor stator or rotor coils.

Machine Fault Models incorporate the Machine Faults as sources of noise n(t) and/or changes in system parameters consistent with imperfections, faults and degradation modes of a particular machine element. Noise will be defined as any signal component that should not be in the perfectly transmitted and received message signal yₒ(t). This may includes harmonics generated by nonlinear elements.

Degraded Machine Model: This is the overall system model that results from adding the Machine Fault Models to the Healthy Machine Model. It includes sources of noise n(t) and changes in system parameters. When all noise sources are zero, the healthy machine results. Transmission of the signal x(t) through the degraded machine (noisy communications channel) induces received signal y*(t), generated by signal x(t) (sent through as yₒ(t)) and noise n(t).

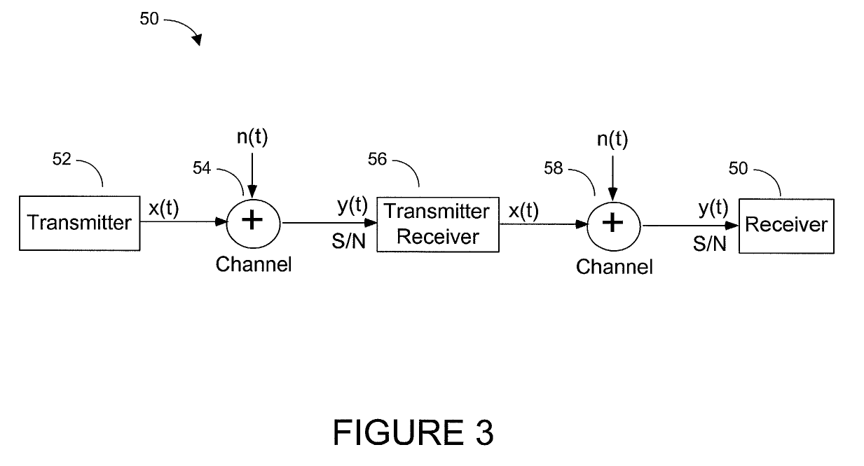

The analogy may also be extended to a set of machines, a process, a manufacturing or assembly method, or others. The analogy may hold for a series of “information channels” as seen in FIG. 3.

The model-based diagnostics is based on fundamental first principles of physics and information theory. The methods uses sensor signals to tune the parameters of a model of the system, such that the model then mimics the operation of the real system. Diagnostics are performed on the model. The diagnostic system can be designed as part of the design of a new machine. Also, models allow what if predictive scenarios for a machine's possible future health and functional condition, given certain observed trends in the machine's health. For a different machine or a new design, only the model of the operation of the system must be altered, not the basic diagnostic algorithm. Models also avoids interpretation of complex sensor signals, trying to figure out what a particular peak or dip, or a band of frequencies in a signal means, in terms of machine health. Instead, time wise changes to machine parameters can be followed, and projection of these trends can be used to forecast future health. Models also permit incorporation of knowledge of faults, and the intent of the designers of machinery, into the diagnostics routines.

To quantitatively analyze transmission through the channel Shannon introduced a measure of the amount of information in a message. The measure is related to the probability of occurrence of the events for which the messages are about. A message that informs the receiver that a rarely occurring event is about to happen contains the most information. A message informing about an already “known” event conveys little information. Information entropy, a measure of the average amount of information (or uncertainty) in a message, can be defined [1] as

$$H = \{ \begin{matrix}- {\sum }_{i = 1}^{n} {p}_{i} {log}_{2} {p}_{i} & if x is discrete \\ - {\sum }_{- ∞}^{∞} p ( x ) {log}_{2} p ( x ) d x & if x is continuous\end{matrix} \qquad ( 1 )$$

Here pᵢ is the probability of occurrence of the message's event x_{I} if the random variable is discrete, and p(x) is the probability density function for the random variable x, if the random variable x is continuous. Here pᵢ is the probability of occurrence of the message's event x, x_{I} if the random variable is discrete, and p(x) is the probability density function for the random variable x, if the random variable x is continuous.

Shannon's entropy rate (R) measured a source's information production rate, and the channel capacity (C) measured the information carrying capacity of the channel. As per one of Shannon's theorems [1], if R≦C, then there exists a coding technique which enables transmission over the channel with an arbitrarily small frequency of errors. This restriction holds even with bounds the noise in the channel. A converse to this theorem states that it is not possible to transmit messages without errors if R>C. Thus the channel capacity is defined as the maximum rate of reliable information transmission through the channel.

In another theorem, Shannon derived the channel capacity for a time continuous channel with additive white Gaussian noise. His expression

$$C = ω {log}_{2} ( 1 + \frac{S}{N} ) \qquad ( 2 )$$

involves the average transmitter power,

$$S = P \{ {x}_{o} ( t ) \} = \frac{1}{T} {\int }_{0}^{T} {[ {x}_{o} ( t ) ]}^{2} ⅆ t \qquad ( 3 )$$

of the signals xₒ(t), the power of the noise,

$$N = P \{ n ( t ) \} = \frac{1}{T} {\int }_{0}^{T} {[ n ( t ) ]}^{2} ⅆ t \qquad ( 4 )$$

and bandwidth ω of the channel in hertz. If the bandwidth is non-flat, then the capacity of the channel is given by

$$C = {\int }_{0}^{ω} {log}_{2} ( 1 + \frac{S ( f )}{N ( f )} ) ⅆ f . \qquad ( 5 )$$

Similarly, the entropy or information rate for messages

R=ωᵢ log₂(Sᵢ/Nᵢ) (6)

derived by Shannon involves Sᵢ, the average power of the desired signal to be transmitted, Nᵢ, the maximum allowed RMS error between recovered and original messages, and ωᵢ, the signal bandwidth.

Shannon's communication theory could be applied to the fault diagnosis of machine systems. A machine component (or system) accepts a signal from an upstream component, by its function alters that signal, and then passes the signal on to the next downstream component. In Bryant's analogy, a machine conveys information in a signal and is thus a communications channel. When operating properly, the signal passes through the system and is successfully received within desired tolerances at the machine's output. Faults that disrupt operation alter the flow of signal. Faults will be viewed as agents that contaminate the machine's signal with “noise”. Unless the signal to noise ratio (S/N) is kept sufficiently high, downstream components cannot resolve the signal message error free, and the machine malfunctions.

Noise is defined as an “unwanted signal tending to obscure or interfere with a desired signal”, as “any signal which interferes with the transmission of a signal through a network or tends to mask the desired signal at the output terminals of the network”, and as “an unwanted signal tending to interfere with a required signal”. Thus noise is the difference between the actual signal received, and the signal desired to be received. To apply this definition to mechanical systems, we must define the desired signal. We shall call this desired signal the “ideal” signal xₒ(t). Note that xₒ(t), an idealization, must be produced by a system without noise. This is possible only with models, not with real systems.

The “ideal” and “degraded” models may be defined as follows:

The ideal machine model has no faults and functions perfectly. Its output defines the signal xₒ(t) that the machine channel is supposed to receive. From this, we can estimate signal power Sᵢ.

The degraded machine model is the overall system model that results from adding faults to the model. We will incorporate faults as noise n(t). Thus the signal x(t)=xₒ(t)+n(t) contains noise n(t), defined as any signal component that should not be in the perfectly received message signal. Noise is any deviation from the ideal signal, including unwanted harmonics generated by nonlinear elements. This will estimate the noise power N.

We can incorporate degradation or imperfections into the system model. Degradation can be instilled in a bond graph model by varying bond graph parameters, adding noise (effort or flow) sources, or changing the power pathways.

The models may take various forms. These forms may be any form appropriate for use in the system of application. For example, these forms may be heuristic, neural networks, deterministic, probabilistic, and others.

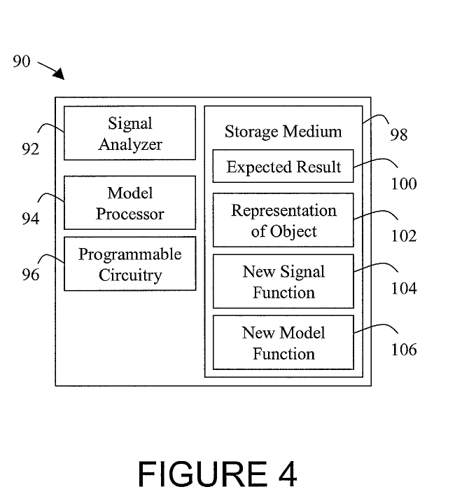

The method and model system may be implemented on a computer system, S see FIG. 4). The term “computer system” as used herein generally describes the hardware and software components that in combination allow the execution of computer programs. The computer programs may be implemented in software, hardware, or a combination of software and hardware. A computer system's hardware generally includes a processor, memory media, and input/output (I/O) devices. As used herein, the term “processor” generally describes the logic circuitry that responds to and processes the basic instructions that operate a computer system. The term “memory medium” includes an installation medium, e.g., a CD-ROM, floppy disks; a volatile computer system memory such as DRAM, SRAM, EDO RAM, Rambus RAM, etc.; or a non-volatile memory such as optical storage or a magnetic medium, e.g., a hard drive. The term “memory” is used synonymously with “memory medium” herein. The memory medium may comprise other types of memory or combinations thereof. In addition, the memory medium may be located in a first computer in which the programs are executed, or may be located in a second computer that connects to the first computer over a network. In the latter instance, the second computer provides the program instructions to the first computer for execution. In addition, the computer system may take various forms, including a personal computer system, mainframe computer system, workstation, network appliance, Internet appliance, personal digital assistant (PDA), television system or other device. In general, the term “computer system” can be broadly defined to encompass any device having a processor that executes instructions from a memory medium.

The memory medium preferably stores a software program or programs for the reception, storage, analysis, and transmittal of information produced by an Analyte Detection Device (ADD). The software program(s) may be implemented in any of various ways, including procedure-based techniques, component-based techniques, and/or object-oriented techniques, among others. For example, the software program may be implemented using ActiveX controls, C++ objects, 7avaBeans, Microsoft Foundation Classes (MFC), or other technologies or methodologies, as desired. A CPU, such as the host CPU, for executing code and data from the memory medium includes a means for creating and executing the software program or programs according to the methods, flowcharts, and/or block diagrams described below.

A computer system's software generally includes at least one operating system such Windows NT available from Microsoft Corporation, a specialized software program that manages and provides services to other software programs on the computer system. Software may also include one or more programs to perform various tasks on the computer system and various forms of data to be used by the operating system or other programs on the computer system. The data may include but is not limited to databases, text files, and graphics files. A computer system's software generally is stored in non-volatile memory or on an installation medium. A program may be copied into a volatile memory when running on the computer system. Data may be read into volatile memory as the data is required by a program.

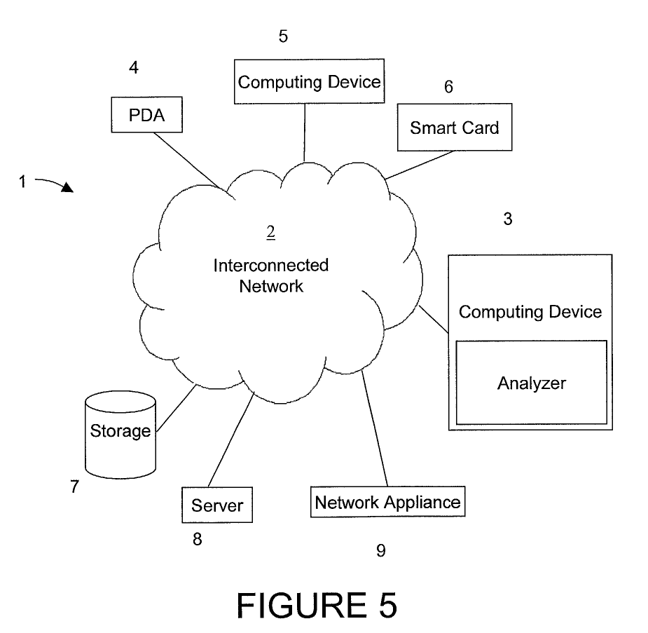

Further, the method may be implemented across a set of networked devices (See FIG. 5). The method may be performed remotely from the system. Further, the results of the method may be transmitted, stored, processed, and accessed across a network, among others.

For example, parameters for a model of a patient's health may be stored on a smart card. These may be accessed and combined with the method to determine a change in state of the patient's health. In another exemplary embodiment, a machine may be located in a remote location. A service provider may periodically access data from the machine from a remote location and diagnose the machine. These diagnoses may be used in predicting the failure of the machine. Further, these diagnoses may be used in placing an order for a replacement.

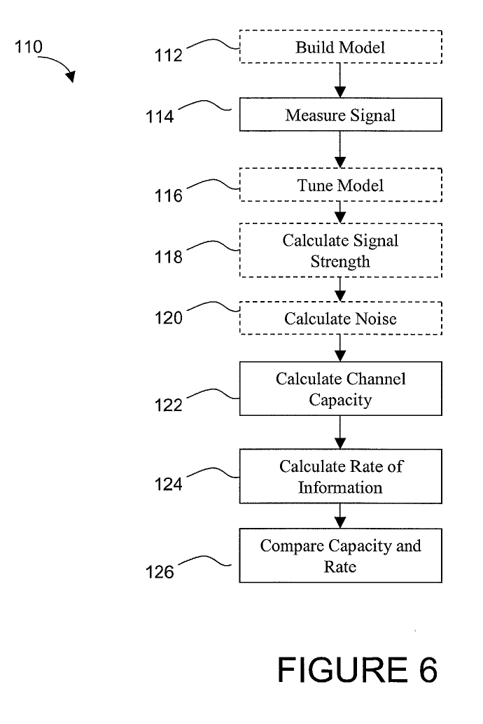

FIG. 6 depicts a flowchart for diagnosing according to the invention. The method may be implemented in software and/or hardware. Further the method may include some or all of the steps in various combinations.

In a first step, the user is directed to assemble detailed dynamic systems models of the machine system in question. The models may possess a one to one correspondence between physical components or elements in the real physical system, and elements in the dynamic systems model. One may include all possible faults and potential failures in the system models. This invention may tabulate the effects of faults as “noise” in the system. Noise in a signal is the difference between the actual signal and the expected signal. In the model, noise may be induced by changes in parameters of dynamic system elements, which then alters any signals passing through a system. Or, if a certain fault cannot be described by these means, then sources of noise (often white noise) will be inserted into the system model, at locations in the model that are consistent with the locations of the faults in the real machine. The intensity of these noise sources can then be adjusted to make the model behave like the real machine.

One may then judiciously monitor the machine or system. Excite the machine or system, and observe the machine's or system's response, for example, via the sensor outputs.

One may then tune the model's parameters, so the model mimics the real system. Excite the system model with the same excitation as the previous list item. Compare the outputs of the model to the corresponding outputs of the real machine or system. If the model's outputs differ from the real machine's or system's outputs, adjust or change values of model parameters, including the intensity of the noise sources, until the model's outputs closely match the actual system's outputs.

One may then manipulate the model, which now mimics the real machine or system in its present condition:

From the model, one may calculate the channel capacity, C, of the machine. C is the maximum amount of information that can be observed successfully conveyed through the machine. The channel capacity depends on the design and construction of the system, and the present condition of the system, which results from manufacture, aging and damage. Faults are encoded as “noise” in the model. Analytically, C depends on the strength of the noise levels in the system, relative to the strength of the excitation system response signal.

For a desired job to be performed by the machine, one may calculate the rate of information R associated with the job. R depends of the desired speed at which the machine does the job, the desired loads, the complexity of the job, and the desired accuracy at which the machine should do the job. R is measured in bits of information per second.

Compare R to C. If R≦C, the machine will perform the desired job within the desired precision. If not, the system has functionally failed.

The comparison of R to C may yield a diagnosis. Alternately parameters of the tuned model may yield a diagnosis. Further, this diagnosis may be associated with the determined noise. In addition, the noise and/or diagnosis may be indicative of combined faults. Further, combined variances in parts, while within tolerance limits, may comprise a fault, defect, or others.

The method may be repeated over time to build a prognosis of the machine or system. For example, a prognosis may predict the failure of a part.

Further, the method may be applied to many systems such as those depicted above. In addition, parameters from the tuned model may indicate the type or state of a defect, fault, illness, or condition, among others.

In typical applications, the method may involve formulation of extremely detailed models of machine devices to describe a machine's condition. These are critical to success. For example, included are bond graph based models of a motor, a gear box, and other mechanical transmission components. These extremely detailed models: (a) exhibit a one to one correspondence between elements in the model and components in the real system; (b) incorporate all known effects of the device into the model, including defects; (c) include in the models via finite element concepts instilled into bond graphs the dynamically distributed nature of components in the real system, and (d) use noise sources to account for defects and degradation of components. Simulation of the motor and gear box models can generate the complex spectra measured during operation of these devices.

The models tabulate the effects of system faults (machine maladies) in a very novel way: as “noise” in the machine. Noise is the difference between the actual signal received, and the expected signal that should be received. As a machine degrades or ages, the difference between actual and expected signals becomes larger, and thus noise levels increase. These noise methods permit incorporation of faults into the models that heretofore could not be described analytically. The concept of noise has been used heavily in electronics and communications engineering, to design around noise “faults” always present in these electronic and electromagnetic systems. Electronic noise, including resistor noise, shot noise, burst noise, and flicker noise among others has been generally tabulated or modeled with noise sources placed in a model of the electronic circuit. This work imported this body of knowledge to mechanical, hydraulic, and other physical systems, but in addition, systems extended the modeling schemes of noise to include noise induced by changes in parameters of the system.

The method also applies techniques of information theory to machinery—as opposed to present applications that are limited to electronic communications systems—to quantitatively assess the current health state of a machine. The method treats a machine, such as a CNC engine lathe, as a noisy communications channel, to assess reliability and functional condition. A message transmitted and received over a communications channel picks up noise due to imperfections present in the physical channel. For example, music transmitted over an AM channel is overwhelmed by buzzing when the receiver is near electrical power transmission lines: the transmitted musical message is obscured at the receiver by electrical noise. In an analogous manner, a machine transmits a message over a machine channel. For example, a lathe, viewed as a communications system, has transmitter=CNC controller, channel=(drive motor+gear box+lead screw,+tool carriage on ways+cutting tool/workpiece), and receiver=workpiece. “Noise” includes effects of fatigue, spurious vibration (from other machines), and other errors due to wear of machine and cutting components. A transmitted “message” is properly “received” if the finished part is within tolerance, or in a general machine, if the machine performs its function within specified tolerances. Excessive noise in the machine system may cause a part to be out of tolerance, or causes the general machine to operate outside the specified tolerance limits. With this view, Shannon's communications theorems may be applied to machinery. Shannon's theorems may accurately estimate the limits on the amount of information per unit time C that can be sent through a noisy communications channel. C depends on the channel's state, including dynamics and signal to noise strengths (ratios). For a lathe, making a part of certain geometric complexity at a given speed, to within a desired (fidelity) tolerance is characterized by an information rate R. If R≦C, Shannon's theorems predict success; if R>C, the part will be out of tolerance. As a machine deteriorates, C decreases, and eventually R>C. Now the machine cannot make the part with the same speed and tolerance. The channel concept appears to be a very sensitive discriminator of a machine system, even for the stacked effects of a collection of moderately degraded components.

The method may be used for predicting the future conditions of machinery, for scheduling maintenance and avoiding functional and catastrophic failures of said machinery. The method can forecast if a complex system is capable of doing a given task, within a specified tolerance. A multitude of parameters associated with the machine's model may be tuned, such that the model emulates the real system.

These modeling and system assessment techniques could be useful to designers of machinery, to assess the efficacy, reliability and durability of a design under various user conditions.

In addition to mechanical systems, these methods could apply to almost any kind of dynamic system, including chemical, electrical, medical, manufacturing and processing, and business operations, among others. For example, in the medical world, a detailed model describing the dynamics of the cardio-vascular system could be developed. This model would possess multiple parameters that describe behavior and condition of the heart and blood vessels, and their interactions with other body systems such as lungs and kidneys. The model could be tuned from medical signals and data derived from tests and procedures, such as Electro-Cardiogram, blood pressure, and data from lab tests and radiology. After tuning the models, a channel capacity C could be estimated to assess the condition of that system, and compared to a rate of information R. This comparison would assess the health state of the patient. The rate of information would describe the ability of the cardio-vascular system to perform at various levels characterized by task speed, load, complexity, and tolerance. Since the rate contains these factors, degrees of health and sickness could be assessed quantitatively or assessed, in a formal manner. This could automate medical diagnostics. Medical prognostics would extrapolate trends of parameters in the model, or trends contained in the data, and apply the channel capacity and rate of information concepts of communications theory, to forecast future health scenarios.

These methodologies could be extended to evaluate business practices, procedures, and enterprise structures. A business operation has dynamics imposed by its processes, people, and structure. The application would treat an enterprise as an imperfect communications channel, and construct models of information flow through that system. Transmitters—the orders—will send information over imperfect “enterprise communication channels”. Imperfections—problems in the enterprise, or interference between conflicting missions—adds “noise” to channels. Receivers—the customers—must receive the message—the product—within tolerancesustomer expectations—despite noise. The application would define “channels” through enterprise units, construct models that mimic these channels, and then apply communications theory to diagnose and prognose these channels.

The models in these embodiments and claims can take various forms: from structured methods such as bond graphs, differential equations, and finite elements, among others, to heuristic methods such as neural networks, fuzzy logic, expert systems, and other computer methods.

The method for applying communication theory to machines and systems need not be limited to signals derived from models. The method could be extended to signals measured from real systems. Here the ideal signal xₒ(t) could be approximated from measurements taken from a real machine, or from several machines, in excellent condition. The difference between xₒ(t) and the signal x(t) measured from a degraded machine could replace those derived from models, mentioned earlier. Similarly, the difference could be used to confirm that a machine operates within tolerances. Further, an ideal signal could be a signal from a machine with a known defect. The difference between the signals would then confirm a specific defect, among others.

Exemplary Application to a Squirrel Cage Induction Motor

Equation numbers in this example refer to equations listed in this subsection. Similarly, an appendix is attached that is referenced in this subsection.

One exemplary application of the invention is a method for diagnosing an induction motor. For example, a motor has two major sub systems: a rotating rotor and a static stator. Induction machines can have a wound rotor, or a squirrel cage rotor. Widely used squirrel cage induction machines exhibit great utility for variable speed systems and are simple, rugged, and inexpensive. The squirrel cage rotor is a structure of steel core laminations mounted on a shaft, with solid bars of conducting material in the rotor slots, end rings, and usually a fan. In large machines, the rotor bars may be of copper alloy, driven into the slots and brazed to the end rings. Rotors of up to 50 cm diameter usually have die-cast aluminum bars. The core laminations for such rotors are stacked in a mold, which is then filled with molten aluminum. In this single economical process, the rotor bars, end rings and cooling fan blades are cast at the same time.

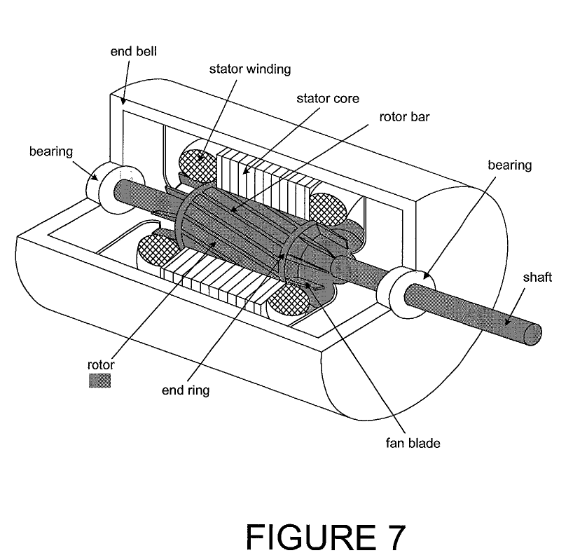

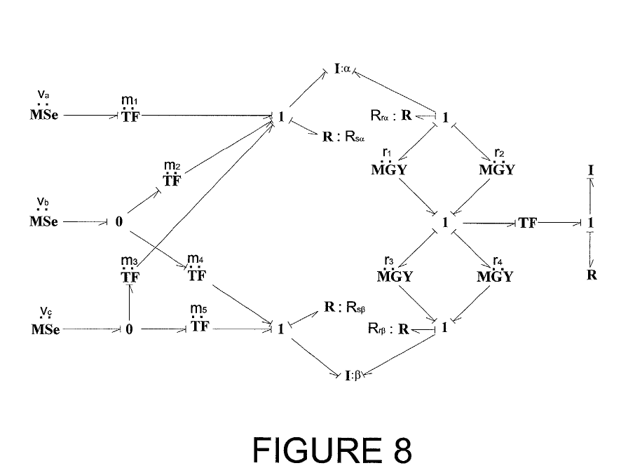

FIG. 7 is a schematic of a squirrel cage induction motor. A substantial literature modeling induction motors employs Park's (1929) two-reaction theory, which accounts for magneto-mechanical energy transduction via multi-port inductances. From Park's model, Ghosh and Bhadra (1993) formulated the bond graph in FIG. 8. We altered Ghosh and Bhadra's bond graph to partition and make explicit the electrical, magnetic, and mechanical energy domains; to form a one to one correspondence between physical components in the machine, and elements in the bond graph; and to append additional elements to the bond graph to make it more consistent with real induction motors.

When energized by an AC supply voltage, the stator coils form a radial magnetic field vector that rotates within the interior of the stator, about its central axis. Within this interior the stator field cuts through the squirrel cage rotor, including conductor bars that extend axially. This time varying field induces a voltage over the rotor bars. Resulting bar currents flow in the sequence: bar→end ring→opposite side bar→opposite end ring→original bar. Induced by this time varying current loop is a secondary magnetic field, which attempts to align with the stator field. However, because the rotating stator field induced the secondary field of the rotor, the stator field leads the rotor field, and consequently, the rotor chases the stator field, always following. This is motor action (Lawrie, 1987). The induction motor speed depends on the speed of the rotating stator field.

The real system we will consider is a two pole, ‘Y’ connected three phase squirrel cage induction motor. In (Ghosh and Bhadra, 1993; Sahm, 1979; and Hancock, 1974), a multi phase induction motor was modeled with an equivalent two-axis representation. Each phase winding generates its own magnetic field, which can be represented as a vector aligned along the axis of the winding. The sum of these phase vectors produces a phasor vector. If the phase vectors vary properly with time, the phasor rotates.

A transformation from three phases (a,b,c) to two phases (α,β) was represented in (Hancock, 1974) in matrix form. If the ‘a’ and ‘α’ phase windings are co-axial, the induced Magneto Motive Forces (MMF) of the ‘a’ and ‘α’ phases of the three and two phase systems are co-directional. By appropriate changes to the two phase currents, the magnitude of the phasors of the three and two phase systems can be made equal. Ghosh and Bhadra (1993) represented this in their bond graph via transformer elements in the stator section. The two phase currents were represented in terms of three phases as

$$[ \begin{matrix}{i}_{α} \\ {i}_{β}\end{matrix} ] = \frac{\sqrt{2}}{\sqrt{3}} [ \begin{matrix}cos 0 & cos 2 π / 3 & cos 4 π / 3 \\ sin 0 & sin 2 π / 3 & sin 4 π / 3\end{matrix} ] [ \begin{matrix}{i}_{a} \\ {i}_{b} \\ {i}_{c}\end{matrix} ] \\ = [ \begin{matrix}\sqrt{2} / \sqrt{3} & - 1 / \sqrt{6} & - 1 / \sqrt{6} \\ 0 & 1 / \sqrt{2} & - 1 / \sqrt{2}\end{matrix} ] [ \begin{matrix}{i}_{a} \\ {i}_{b} \\ {i}_{c}\end{matrix} ] \qquad ( 1 )$$

Under assumptions of a spatially sinusoidal distribution of MMFs, and ignoring magnetic losses and saturation, Ghosh and Bhadra (1993) expressed a symmetric induction motor in an orthogonal stationary reference frame with α and β phases fixed on the stator as

$$[ \begin{matrix}{V}_{α s} \\ {V}_{β s} \\ 0 \\ 0\end{matrix} ] = [ \begin{matrix}{R}_{s} + {L}_{s} \frac{ⅆ}{ⅆ t} & 0 & {L}_{m} \frac{ⅆ}{ⅆ t} & 0 \\ 0 & {R}_{s} + {L}_{s} \frac{ⅆ}{ⅆ t} & 0 & {L}_{m} \frac{ⅆ}{ⅆ t} \\ {L}_{m} \frac{ⅆ}{ⅆ t} & {L}_{m} {ω}_{r} & {R}_{r} + {L}_{r} \frac{ⅆ}{ⅆ t} & {L}_{r} {ω}_{r} \\ - {L}_{m} {ω}_{r} & {L}_{m} \frac{ⅆ}{ⅆ t} & - {L}_{r} {ω}_{r} & {R}_{r} + {L}_{r} \frac{ⅆ}{ⅆ t}\end{matrix} ] [ \begin{matrix}{i}_{α s} \\ {i}_{β s} \\ {i}_{α r} \\ {i}_{β r}\end{matrix} ] \qquad ( 2 )$$

Equation (2) relates stator voltages to stator and rotor currents. In addition, needed is the electromagnetic motor torque for a P-pole machine, expressed as

$${T}_{e} = \frac{P}{2} [ {i}_{α r} ( {L}_{m} {i}_{β s} + {L}_{r} {i}_{β r} ) - {i}_{β r} ( {L}_{m} {i}_{α s} + {L}_{r} {i}_{α r} ) ] \qquad ( 3 )$$

This motor torque is balanced against other torques via

$${T}_{e} = J \frac{ⅆ {ω}_{m}}{ⅆ t} + c {ω}_{m} + {T}_{L} \qquad ( 4 )$$

Terms on the right side of equation (4) represent rotor inertial torque, shaft/bearing damping torque, and load torque, respectively. In equations (2) to (4), V_{αs} and V_{βs} are α and β axis stator voltages; i_{αs} and i_{βs} are α and β axis stator currents; i_{αr} and i_{βr} are α and β axis rotor currents; Rₛ and Rᵣ are stator and rotor resistances; Lₛ, Lₘ and Lᵣ are stator self inductance, mutual inductance and rotor self inductance; Tₑ and T_{L} are electromagnetic torque and mechanical load torque; J is the moment of inertia of the rotor, c is the viscous resistance coefficient; ωᵣ and ωₘ are electrical and mechanical angular velocities of the rotor; and P is number of pole pairs.

Ghosh and Bhadra (1993) represented equations (1) to (4) in their bond graph, reproduced in FIG. 8. They used modulated gyrators MGY:r₁=Lₘi_{βs}, MGY:r₂=Lᵣi_{βr}, MGY:r₃=Lₘi_{αs}, MGY:r₄=Lᵣi_{αr}, to represent the electromagnetic torque of equation (3); employed transformers TF:m₁, TF:m₂, TF:m₃, TF:m₄, TF:m₅ with moduli

$${m}_{1} = \sqrt{\frac{3}{2}} , {m}_{2} = {m}_{3} = - \sqrt{6} , {m}_{4} = \sqrt{2} , {m}_{5} = - \sqrt{2}$$

to implement the mathematical transform of equation (1); and excited the system with effort sources MS_{c}:vₐ, MSₑ:v_{b}, and MSₑ:v_{c} having sinusoidal voltages with equal amplitudes but 0, π/3, and 2π/3 phase lags, respectively. Although this correctly programs the governing equations for a three phase induction motor, it lacks a correspondence between bond graph elements and real system components. Moreover, elements and their constitutive laws involve only electrical and mechanical energy domains. Faults or design parameters relevant to the magnetic domain are only implicit in the mutual inductances, posed as 2 port inertances I:α and I:β with constitutive laws

$$\begin{matrix}[ \begin{matrix}{λ}_{α s} \\ {λ}_{α r}\end{matrix} ] = [ \begin{matrix}{L}_{s} & {L}_{m} \\ {L}_{m} & {L}_{r}\end{matrix} ] [ \begin{matrix}{i}_{α s} \\ {i}_{α r}\end{matrix} ] \\ [ \begin{matrix}{λ}_{β s} \\ {λ}_{β r}\end{matrix} ] = [ \begin{matrix}{L}_{s} & {L}_{m} \\ {L}_{m} & {L}_{r}\end{matrix} ] [ \begin{matrix}{i}_{β s} \\ {i}_{β r}\end{matrix} ]\end{matrix} . \qquad ( 5 )$$

In λ_{αs}, λ_{βs}, λ_{αr}, and λ_{βr} are flux linkage of the respective windings. In FIG. 8, five integral (independent) causalities exist on inertance energy storage elements, with system state variables λ_{αs}, λ_{βs}, λ_{αr}, λ_{βr}, and h, where h is the rotor angular momentum.

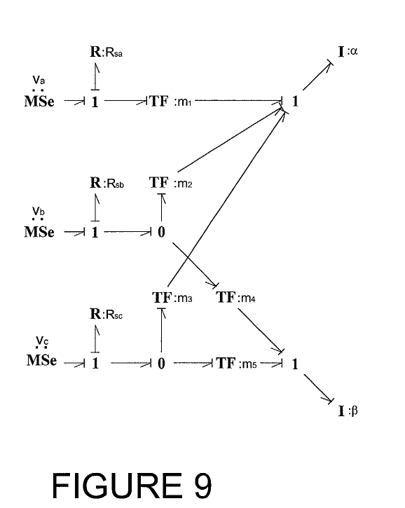

To represent real system elements or components explicitly, certain bond graph elements should be moved, altered or added. In FIG. 8, α and β phase stator resistance elements, R_{sα}, and R_{sβ} should be split into three stator coil resistances Rₛₐ, R_{sb}, and R_{sc}, without alterating the governing equations. The revised bond graph shown in FIG. 9 moved R_{sα} and R_{sβ} back through the transformers in front of the phases. To maintain an equivalence between FIG. 8 and FIG. 9, we must relate Rₛₐ, R_{sb} and R_{sc} to R_{sα}, and R_{sβ}. Since most motors possess symmetry between phases, let Rₛₐ=R_{sb}=R_{sc}=R, and R_{sα} =R_{sβ}=Rₛ. For the bond graphs of FIG. 8 and FIG. 9 to be equivalent, the voltages (efforts) to the 2-port inertances on the stator sides must be equal in both FIG. 8 and FIG. 9. The causality in both FIG. 8 and FIG. 9 asserts that these voltages to the 2-port inertances arise from the neighboring 1-junctions. Summing voltages from other bonds to these 1-junctions, and equating these respective voltages between FIG. 8 and FIG. 9 gives

$$\begin{matrix}\frac{{V}_{b}}{{m}_{4}} + \frac{{V}_{c}}{{m}_{5}} - {R}_{s} {i}_{β s} = \frac{1}{{m}_{4}} \{ {V}_{b} - R ( \frac{{i}_{αs}}{{m}_{2}} + \frac{{i}_{βs}}{{m}_{4}} ) \} + \frac{1}{{m}_{5}} \{ {V}_{c} - R ( \frac{{i}_{αs}}{{m}_{3}} + \frac{{i}_{βs}}{{m}_{5}} ) \} & ( 6 ) \\ \frac{{V}_{a}}{{m}_{1}} + \frac{{V}_{b}}{{m}_{2}} + \frac{{V}_{c}}{{m}_{3}} - {R}_{s} {i}_{α s} = \frac{1}{{m}_{1}} \{ {V}_{a} - R ( \frac{{i}_{αs}}{{m}_{1}} ) \} + & ( 7 ) \\ \frac{1}{{m}_{2}} \{ {V}_{b} - R ( \frac{{i}_{αs}}{{m}_{2}} + \frac{{i}_{βs}}{{m}_{4}} ) \} + \frac{1}{{m}_{3}} \{ {V}_{c} - R ( \frac{{i}_{αs}}{{m}_{3}} + \frac{{i}_{βs}}{{m}_{5}} ) \} . & \end{matrix}$$

By solving for i_{βs}/i_{αs}, we obtain equations in terms of resistances and transformer moduli

$$\begin{matrix}\frac{{i}_{β s}}{{i}_{α s}} = \frac{( {m}_{3} {m}_{4} {m}_{5}^{2} + {m}_{2} {m}_{4} {m}_{5}^{2} ) R}{{m}_{2} {m}_{3} {m}_{4}^{2} {m}_{5}^{2} {R}_{s} - ( {m}_{2} {m}_{3} {m}_{5}^{2} + {m}_{2} {m}_{3} {m}_{4}^{2} ) R} \\ = \frac{{m}_{1}^{2} {m}_{2}^{2} {m}_{3}^{2} {m}_{4} {m}_{5} {R}_{s} - ( {m}_{2}^{2} {m}_{3}^{2} {m}_{4} {m}_{5} + {m}_{1}^{2} {m}_{3}^{2} {m}_{4} {m}_{5} + {m}_{1}^{2} {m}_{2}^{2} {m}_{4} {m}_{5} ) R}{( {m}_{1}^{2} {m}_{2} {m}_{3}^{2} {m}_{5} + {m}_{1}^{2} {m}_{2}^{2} {m}_{3} {m}_{4} ) R}\end{matrix} \qquad ( 8 )$$

By replacing the transformer moduli, m₁˜m₅ of the three phase to two phase transformation with real numbers,

$${m}_{1} = \sqrt{\frac{3}{2}} , {m}_{2} = {m}_{3} = - \sqrt{6} , {m}_{4} = \sqrt{2} , {m}_{5} = - \sqrt{2} ,$$

which is given in equation (1), we find that Rₛ=R, i.e., R_{sα}=R_{sβ}=Rₛₐ=R_{sb}=R_{sc}.

Simplified Representation of the Signal and Modulated GY Elements

In terms of the 2-port I field of equation (5), equation (3) can be rewritten as

$${T}_{e} = \frac{P}{2} ( {λ}_{β r} {i}_{α r} - {λ}_{α r} {i}_{β r} ) \qquad ( 9 )$$

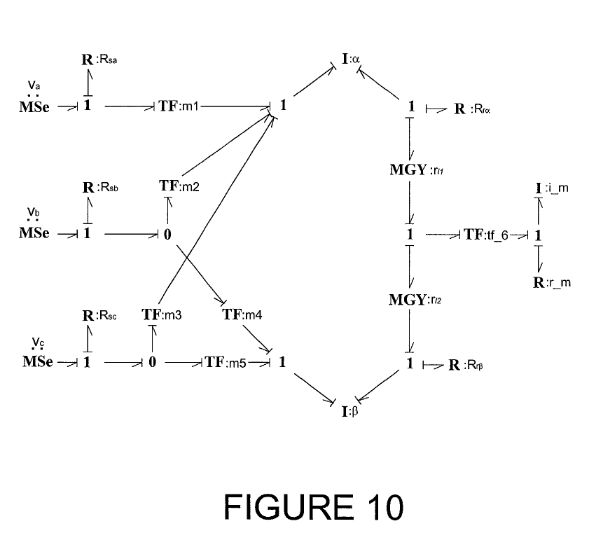

From this relation, FIG. 8 can be rearranged into the form of FIG. 10, where the modulated gyrators MGY: r₁₁=λ_{βr} and MGY: r₁₂=λ_{αr} are modulated by the flux linkages λ_{αr} and λ_{βr} of the 2-port inertances.

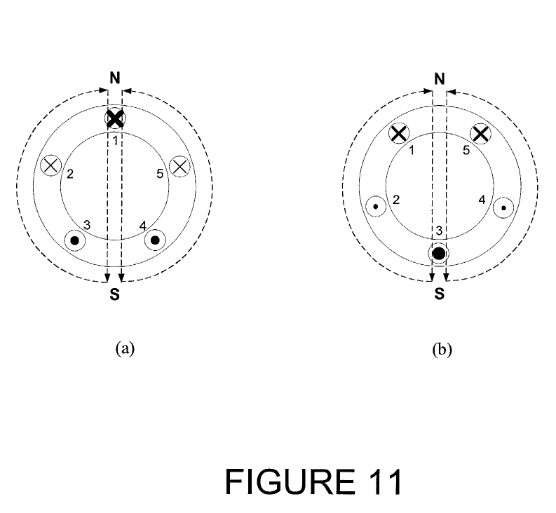

The number of squirrel cage rotor bars depends on the rotor's size, and usually, tens of bars are in one rotor. In this study we consider the squirrel cage rotor with five bars (numbered 1 to 5) depicted in FIG. 11. Shown also is the rotor magnetic field (dashed line), with north poles (N) on top of the rotor, and south poles (S) beneath, and bar currents. Currents directed out of plane are denoted by a ‘•’, and currents flowing into the plane are denoted by a ‘x’. Each end of each rotor bar is attached to a solid end ring. Induced currents flow through each bar and end rings. With five bars, there exist five different currents (flows) in this rotor. At the instant of the rotor position shown in FIG. 11-(a), the sums of the currents induced by the rotating magnetic field of the stator in bar 1, 2 and 5 must be equal to the sum of the currents in bar 3 and 4. Likewise, the current summation of bar 1 and 5 at the position of FIG. 11-(b) must equal the sum of currents in bars 2, 3 and 4. In FIG. 11, the thickness of each x and • shows the relative current magnitude in each bar.

To incorporate individual rotor bars into the bond graph, the α and β phase currents and voltages of the rotor should be split into separate bar currents and voltages. The a, b, c and α, β axes are stationary with respect to the stator, but because the rotor rotates relative to these axes, bar currents must depend on the rotation angle θ of the rotor. Using results in Hancock (1974), rotor bar currents can be related to the α, β phase currents as

$${i}_{rk} = m [ {i}_{α r} cos \{ θ + \frac{2 ( k - 1 ) π}{n} \} + {i}_{β r} sin \{ θ + \frac{2 ( k - 1 ) π}{n} \} ] \qquad ( 10 )$$

In equation (10), iᵣₖ represents the current in the k^{th} rotor bar (k=1, 2, . . . n), λ_{αr}, and λ_{βr} are rotor currents from FIG. 8, and magnitude modulus m depends on the total number of bars, n. For n=5 bars, we will have currents iᵣ₁ to iᵣ₅. Accordingly, rotor bars can be incorporated into the bond graph of FIG. 10 via θ-modulated transformers.

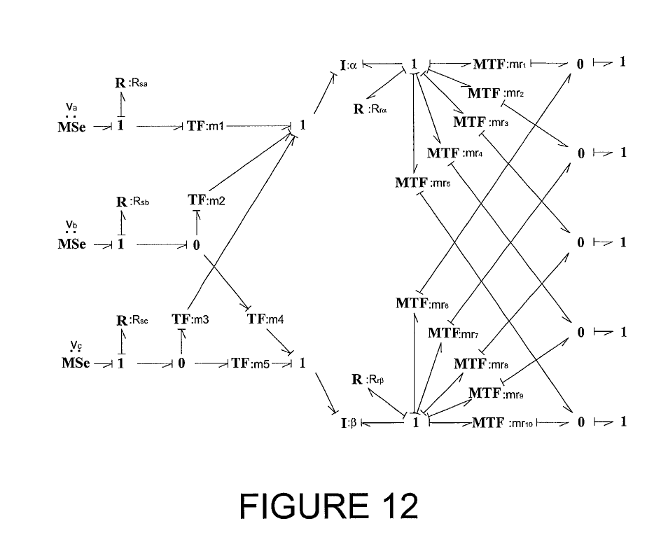

FIG. 12 shows the transformation of α and β phase currents into individual rotor bar currents, where the transformer moduli are

$$\begin{matrix}{mr}_{k} = m cos \{ θ + \frac{2 ( k - 1 ) π}{n} \} k = 1 , 2 , … , n & ( 11 ) \\ {mr}_{k + n} = m sin \{ θ + \frac{2 ( k - 1 ) π}{n} \} with n = 5. & ( 12 )\end{matrix}$$

In FIG. 12, the battery of 0-junctions on the right side completes the summation of α and β phase currents demanded by the right side of equation (10). The voltages that sum over the two 1 junctions located between the I fields and the MTF's give rise to

λ_{αr}+(mr₁)+(mr₂)+ . . . +(mr₅)λ₅=0

λ_{βr}+(mr₆)λ₆+(mr₇)λ₇+ . . . +(mr₁₀)λ₁₀=0 (13)

Here the flux linkage λ₁, λ₂, . . . , λ₁₀ associated with rotor bars are located to the right of the MTF's. To obtain the torque contributed by each bar, equation (10) for k=1, 2, . . . , 5 is rewritten in matrix form as

$$[ \begin{matrix}{i}_{r1} \\ {i}_{r2} \\ {i}_{r3} \\ {i}_{r4} \\ {i}_{r5}\end{matrix} ] = m [ \begin{matrix}cos θ & sin θ \\ cos ( θ + \frac{2 π}{5} ) & sin ( θ + \frac{2 π}{5} ) \\ cos ( θ + \frac{4 π}{5} ) & sin ( θ + \frac{4 π}{5} ) \\ cos ( θ + \frac{6 π}{5} ) & sin ( θ + \frac{6 π}{5} ) \\ cos ( θ + \frac{8 π}{5} ) & sin ( θ + \frac{8 π}{5} )\end{matrix} ] [ \begin{matrix}{i}_{α r} \\ {i}_{β r}\end{matrix} ] i . e . {i}_{rotor} = {Ai}_{two phase} \qquad ( 14 )$$

The two column vectors of the 5×2 transformation matrix A form an orthogonal set for any value of rotor rotation angle θ; the rank of A is 2. For the m×n (m□n) matrix A having rank n, there exists (Strang, 1988) an n×m left-inverse B such that BA=Iₙ, where Iₙ is the identity matrix of order n. In our model

$${A}^{T} A = {m}^{2} \frac{5}{2} [ \begin{matrix}1 & 0 \\ 0 & 1\end{matrix} ] \qquad ( 15 )$$

and the left-inverse of A is A^{T} if

$${m}^{2} = \frac{2}{5} ,$$

i.e., the transformer modulus m has a value which normalizes A^{T}A. For a rotor of n bars,

$$m = \sqrt{\frac{2}{n}} .$$

The proof is shown in Appendix for this subsection. From equations (14) and (15), the inverse transformation is

$$[ \begin{matrix}{i}_{α r} \\ {i}_{β r}\end{matrix} ] = \frac{\sqrt{2}}{\sqrt{5}} [ \begin{matrix}cos θ & cos ( θ + \frac{2 π}{5} ) & cos ( θ + \frac{4 π}{5} ) & cos ( θ + \frac{6 π}{5} ) & cos ( θ + \frac{8 π}{5} ) \\ sin θ & sin ( θ + \frac{2 π}{5} ) & sin ( θ + \frac{4 π}{5} ) & sin ( θ + \frac{6 π}{5} ) & sin ( θ + \frac{8 π}{5} )\end{matrix} ] [ \begin{matrix}{i}_{r1} \\ {i}_{r2} \\ {i}_{r3} \\ {i}_{r4} \\ {i}_{r5}\end{matrix} ] \qquad ( 16 )$$

If substituted into the rotor output torque equation (9), the electromagnetic torque becomes

$$\begin{matrix}{T}_{e} = {\sum }_{k = 1}^{5} {T}_{k} = \frac{P}{2} {\sum }_{k = 1}^{5} \frac{\sqrt{2}}{\sqrt{5}} [ {λ}_{β r} cos ( θ + \frac{2 ( k - 1 ) π}{n} ) - \\ {λ}_{α r} sin ( θ + \frac{2 ( k - 1 ) π}{n} ) ] {i}_{rk}\end{matrix} \qquad ( 17 )$$

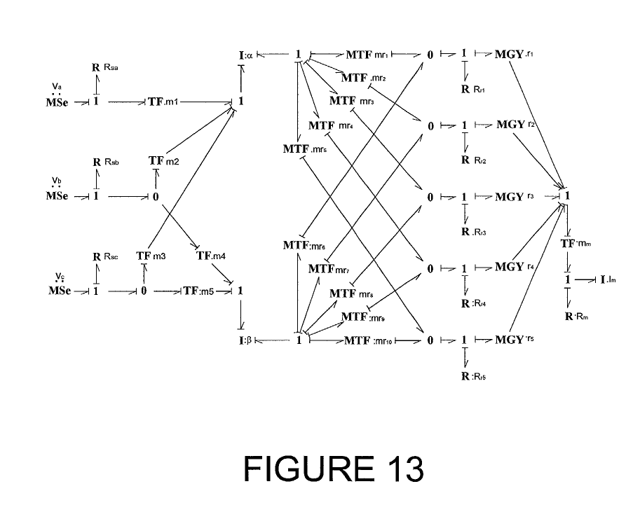

The revised bond graph in FIG. 13 includes stator and rotor bar interactions based on equation (17). Here the moduli of the k^{th} modulated gyrator is

$${r}_{k} = \sqrt{\frac{2}{n}} [ {λ}_{β r} cos ( θ + \frac{2 ( k - 1 ) π}{n} - {λ}_{α r} sin ( θ + \frac{2 ( k - 1 ) π}{n} ) ] \qquad ( 18 )$$

where n=5 for FIG. 13. Finally, the electric resistances of the rotor were grouped with each rotor bar in a manner similar to that of the stator resistances.

The bond graph in FIG. 13 models the interaction between stator coils and rotor bars with 2-port I elements—-inductances—-in the electrical energy domain. An inductance only describes storage of magnetic energy. Neglected are power losses and leakage effects in the magnetic domain, which may be caused by component deterioration. To describe these interactions, we replace all I inductance elements with equivalent combinations of gyrators and C elements, without violating causality. Figure shows equivalent bond graph representations between an I and a GY and C combination; and a TF and GY combination.

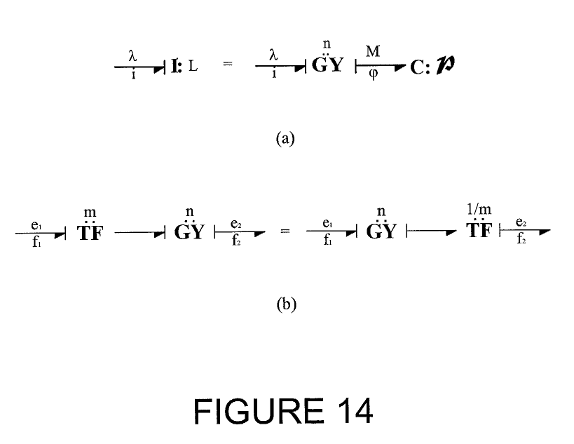

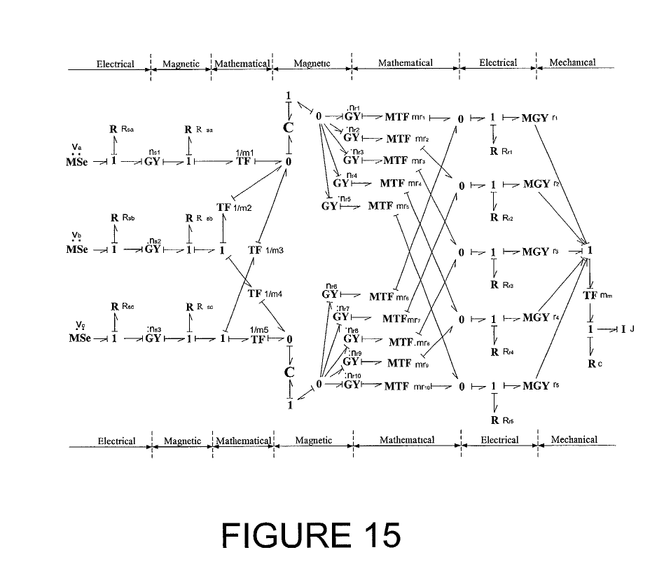

In FIG. 14, n is the gyrator modulus (the effective number of coil turns); m is the transformer modulus; λ is the flux linkage; φ is the magnetic flux [Wb]; M is the magneto motive force [A]; [symbol] is the permeance of the magnetic circuit element [H]; e₁ and e₂ are efforts; and f₁ and f₂ are flows. In FIG. 14-(a), through the gyrator relations λ=nφ and ni=M. Using the constitutive law of the C element, M=φ/ [symbol] , the two port I elements pertaining to the α and β phases were converted into 2-port C elements that now represent interactions between magnetic flux and magnetomotive force of the stator and rotor. FIG. 15 shows the new bond graph with five rotor bars and the GY-C-GY combination that replaced the 2-port I. The gyrators were then moved through the bond graph to new locations more consistent with motor components. The GY to the left of the 2-port C was moved into the electrical section, where it now represents the action and number of turns of the stator coils. The GY leap-frogged the transformers that were based on equation (1), changing moduli of these transformers according to FIG. 14-(b). The GY to the right of the 2-port C skipped over a 1-junction, converting that 1-junction into the 0-junction shown in FIG. 15. Similarly, a 0- and 1-junction to the left of the 2-port C in FIG. 13 were converted to a 1- and 0-junction in FIG. 15. In the bond graph of FIG. 15, electrical energy inputs, transformation of energy from electrical domain to magnetic domain, mathematical phase transformations, power interactions between stator and rotor bars in terms of magnetic flux and magneto motive force, and mechanical rotor output are all represented and labeled. In FIG. 15, the two sets of gyrator moduli nₛ and nᵣ stand for the effective coil turns which relate electrical and magnetic variables of stator and rotor, respectively.

State equations were derived from the bond graph of FIG. 15 with nₛ₁=nₛ₂=nₛ₃=nₛ, Rₛₐ=R_{sb}=R_{sc}=Rₛ. In terms of magnetic variables, the state equations are

$${\dot{ϕ}}_{α s} = \frac{{V}_{a}}{{n}_{s} {m}_{1}} + \frac{{V}_{b}}{{n}_{s} {m}_{2}} + \frac{{V}_{c}}{{n}_{s} {m}_{3}} - {R}_{s} {n}_{r}^{2} l ( {P}_{r} {ϕ}_{α s} - {P}_{m} {ϕ}_{α r} ) \\ {\dot{ϕ}}_{β s} = \frac{{V}_{b}}{{n}_{s} {m}_{4}} + \frac{{V}_{c}}{{n}_{s} {m}_{5}} - {R}_{s} {n}_{r}^{2} l ( {P}_{r} {ϕ}_{β s} - {P}_{m} {ϕ}_{β r} ) \\ {\dot{ϕ}}_{α r} = - {R}_{r} {n}_{s}^{2} l ( - {P}_{m} {ϕ}_{α s} + {P}_{s} {ϕ}_{α r} ) + {ϕ}_{β r} \frac{h}{{m}_{6} J} \\ {\dot{ϕ}}_{β r} = - {R}_{r} {n}_{s}^{2} l ( - {P}_{m} {ϕ}_{β s} + {P}_{s} {ϕ}_{β r} ) + {ϕ}_{α r} \frac{h}{{m}_{6} J} \\ \dot{h} = \frac{{P}_{m}}{{m}_{6} ( {P}_{s} {P}_{r} - {P}_{m}^{2} )} [ - {ϕ}_{α s} {ϕ}_{β r} + {ϕ}_{α r} {ϕ}_{β s} ] - c \frac{h}{{m}_{6} J} \qquad ( 19 )$$

where the magnetic state variables are stator and rotor phase fluxes φ_{αs}, φ_{βs}, φ_{αr}, φ_{βr} and rotor angular momentum h. The constitutive law of the 2-port C element is

$$\begin{matrix}[ \begin{matrix}{ϕ}_{α s} \\ {ϕ}_{α r}\end{matrix} ] = [ \begin{matrix}{P}_{s} & {P}_{m} \\ {P}_{m} & {P}_{r}\end{matrix} ] [ \begin{matrix}{M}_{α s} \\ {M}_{α r}\end{matrix} ] \\ [ \begin{matrix}{ϕ}_{β s} \\ {ϕ}_{β r}\end{matrix} ] = [ \begin{matrix}{P}_{s} & {P}_{m} \\ {P}_{m} & {P}_{r}\end{matrix} ] [ \begin{matrix}{M}_{β s} \\ {M}_{β r}\end{matrix} ]\end{matrix} \qquad ( 20 )$$

In the state equations,

$$l = \frac{1}{{L}_{s} {L}_{r} - {L}_{m}^{2}} = \frac{1}{{n}_{s}^{2} {n}_{r}^{2}} \frac{1}{{P}_{s} {P}_{r} - {P}_{m}^{2}} \qquad ( 21 )$$

where the permeances

$${P}_{s} = \frac{{L}_{s}}{{n}_{s}^{2}} , {P}_{m} = \frac{{L}_{m}}{{n}_{s} {n}_{r}} , {P}_{r} = \frac{{L}_{r}}{{n}_{r}^{2}}$$

are expressed in terms of coil turns and inductances of stator and rotor. Here nₛ is the number of effective stator coil turns, nᵣ the number of effective rotor coil turns, φ the magnetic flux [Wb], M the magnetomotive force [A], P is the Permeance [H], and h the angular momentum [N·m·s=kg·m²·sec].

Simulations of a squirrel cage induction motor used the bond graph simulation tool, 20-SIM (Control Lab Products, 1998). For integration of state equations, a Runge-Kutta 4^{th} order method was adopted. Values of the system parameters for the simulations are presented in

Table 1, some were identical to those used by Ghosh and Bhadra.

TABLE 1
System parameters of a two pole,
three phase squirrel cage induction motor

| | | |
|---|---|---|
| Rₛₐ, R_{sb}, R_{sc} [Ω] | Stator coil resistance | 0.0788 |
| Rᵣ₁, Rᵣ₂, . . ., | Rotor bar resistance | 0.0408 |
| Rᵣ₁₀[Ω] | | |
| vₐ, v_{b}, v_{c} [V] | Input voltage amplitude | 230 |
| [Hz] | Input voltage frequency | 60 |
| Lₛ [H] | Stator inductance | 0.0153 |
| Lᵣ [H] | Rotor inductance | 0.0159 |
| Lₘ [H] | Mutual inductance | 0.0147 |
| n | Number of rotor bars | 5 |
| nₛ | Number of effective stator coil turns | 100 |
| nᵣ | Number of effective rotor coil turns (bar) | 1 |
| c [N · s/m] | Mechanical resistance | 0.15 |
| J [kg · m²] | Mechanical inertia | 0.4 |

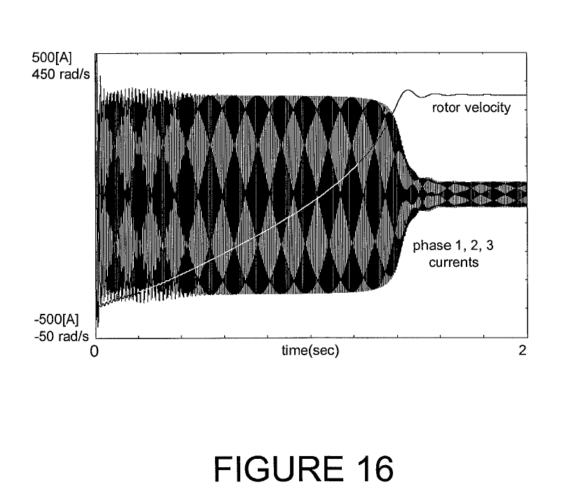

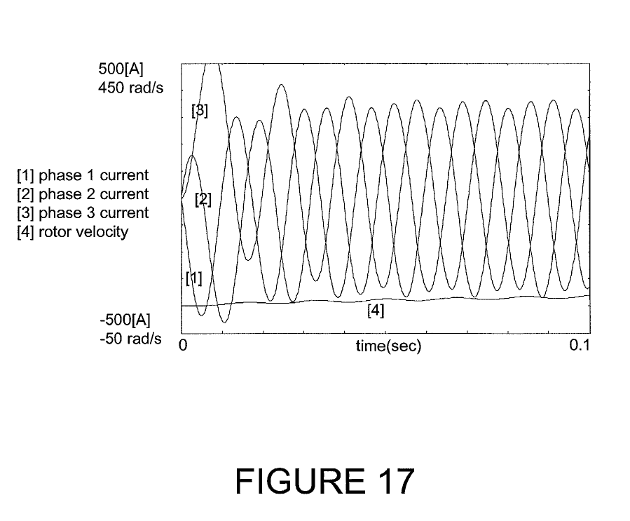

Shown in FIG. 16 and FIG. 17 are plots of rotor angular velocity and stator currents versus time. The rotor velocity rises slowly to a steady state value of about 377 rad/sec; the stator currents oscillate at the input frequency with initial large amplitude. After about 1.5 seconds, the motor reaches steady state: the currents in stator windings decrease to a steady value and no oscillation of rotor velocity exists. FIG. 16 plots the rotor axis angular velocity vs time when 230V, 60 Hz three phase AC voltages are input to the stator coils. Theoretically, when 60 Hz alternating inputs are given to a two pole AC motor, the output velocity should be 3600 RPM (377 rad/sec) and the simulation yields a steady state value very close to this (the difference is due to the mechanical resistance load). FIG. 17 expands the FIG. 16 time scale to show the three stator currents with 1200 phase difference, during motor start-up.

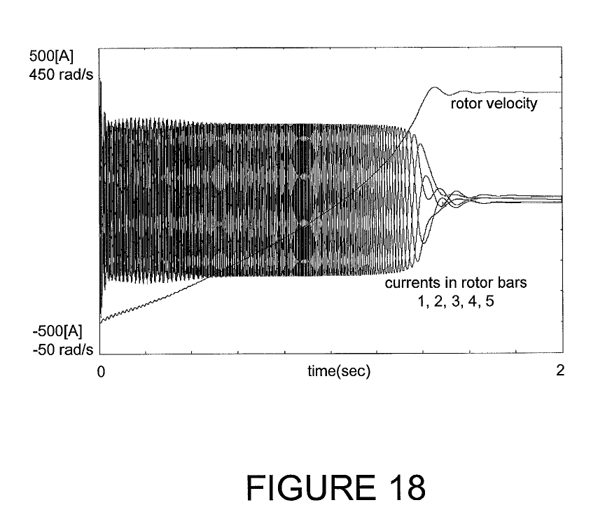

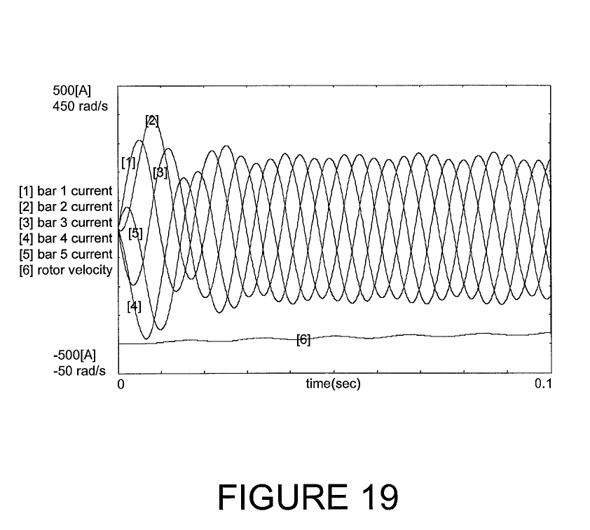

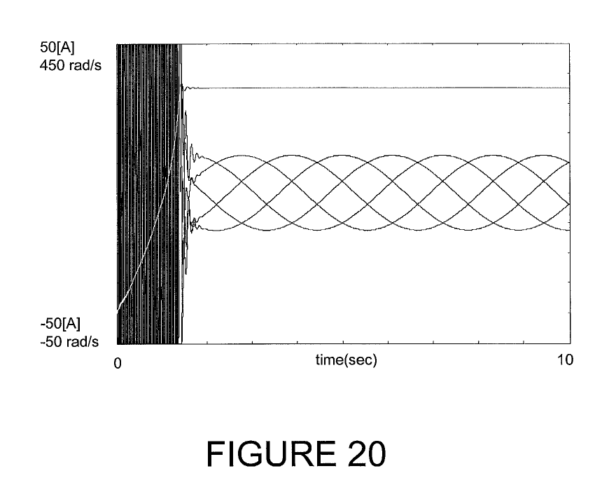

FIG. 18˜20 shows the currents in the five rotor bars and the rotor velocity. Recall there exists 2π/5 phase difference between currents in neighboring bars. This is clearly shown in FIG. 19, which represents the motor starting moment. While the 60 Hz frequency of the stator currents generate a constant rotational velocity of the rotating magnetic field, the frequency of currents in the rotor bars decrease continuously as the rotor velocity increases. This is related to ‘slip’ in induction motors, the normalized difference between the electrical angular velocity of the air gap MMF established by the stator currents, and the electrical angular velocity of the rotor (Krause and Wasynczuk, 1989). Slip is defined as

$$s = \frac{{ω}_{s} - {ω}_{r}}{{ω}_{s}} \qquad ( 22 )$$

where ωₛ is the synchronous speed, or the speed of the stator currents, and ωᵣ is the speed of the rotor. The magnitude and frequency of the currents and voltages of the rotor depend on the relative velocity between the rotating magnetic field and the rotor. In these simulations, this relative velocity maximizes at t=0, where the slip is unity. As the rotor velocity increases, the relative velocity and the slip decrease, suggesting that the decrease of amplitude and frequency of rotor bar currents in FIG. 18 are probably due to the decrease of slip. If ωₛ=ωᵣ, slip s=0 and no current is induced in the rotor bars (hence no torque). However, the steady state currents of the rotor bars in FIG. 18 are not zero, (even though there is no external load) because of the frictional load of the bearing modeled as a resistance R:c in FIG. 15. If an external load is applied to the motor axis, the slip should increase and therefore the current and voltage in the rotor bars should also increase. FIG. 20 shows the currents in the rotor bars during steady state.

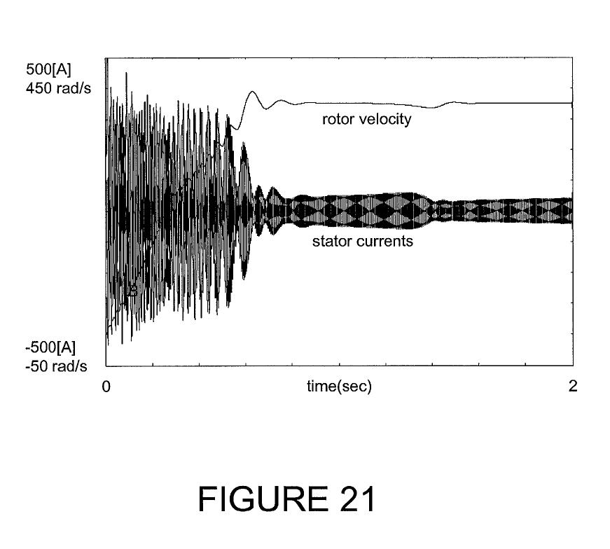

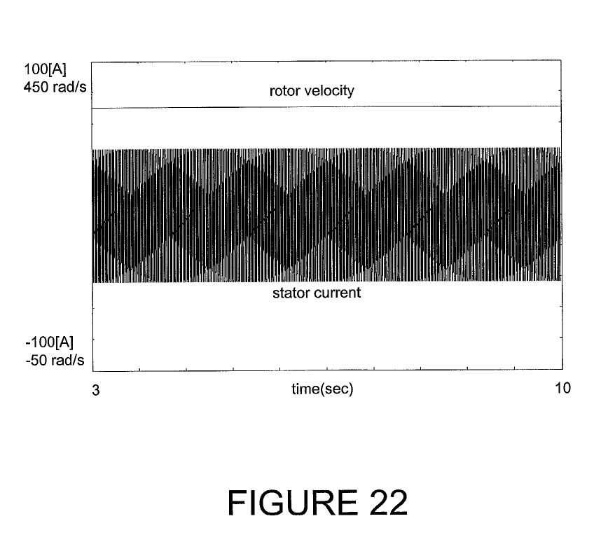

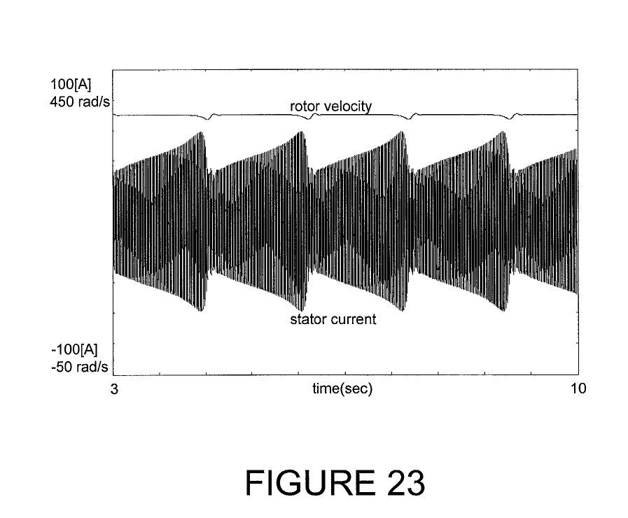

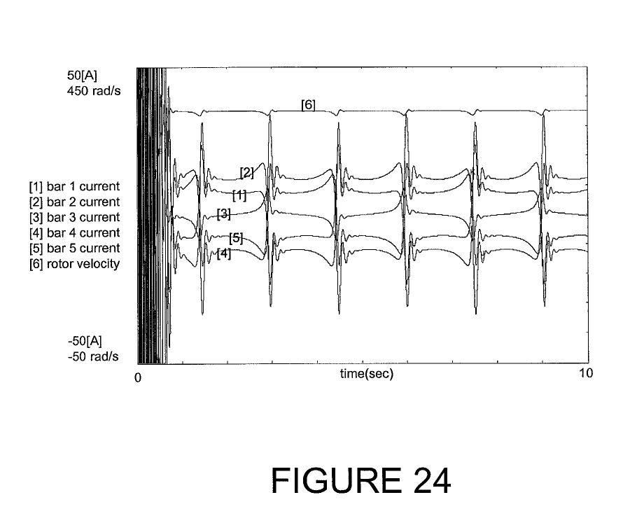

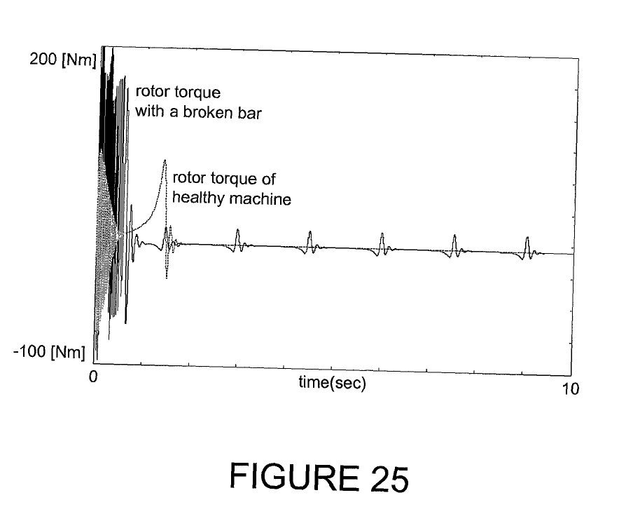

All simulation results shown above are for a healthy motor. When rotor bars break, currents, velocity, and torque will deviate. Because we have a one-to-one correspondence between bond graph elements and machine components, it is possible to represent broken rotor bars by increasing the rotor bar resistance Rᵣ. In modern squirrel cage induction motors, bars and end-rings contact the rotor core. Due to this available current shunt, currents in a broken bar are not zero (Manolas and Tegopolous, 1997), i.e., the resistance is not infinity. FIG. 21 shows the stator currents and rotor velocity for a rotor with the third rotor bar broken. During the transient rise time, the rotor velocity increases, and exhibits oscillations. Even at steady state, there exists periodic deviations of rotor velocity. With these deviations, the amplitude of the currents in the stator coils also change. These changes are more clearly presented in FIG. 23; for comparison, a corresponding healthy machine simulation is shown in FIG. 22. FIG. 24 plots the currents in each rotor bar, with bar 3 assumed broken. From FIG. 24, the induced currents are largest in the two rotor bars nearest the broken bar. FIG. 25 compares the torque characteristics of the healthy machine and broken bar machine. The rotor torque oscillates in the broken bar machine, even at steady state. During startup, the oscillation of torque is larger in the broken bar machine than the healthy machine.

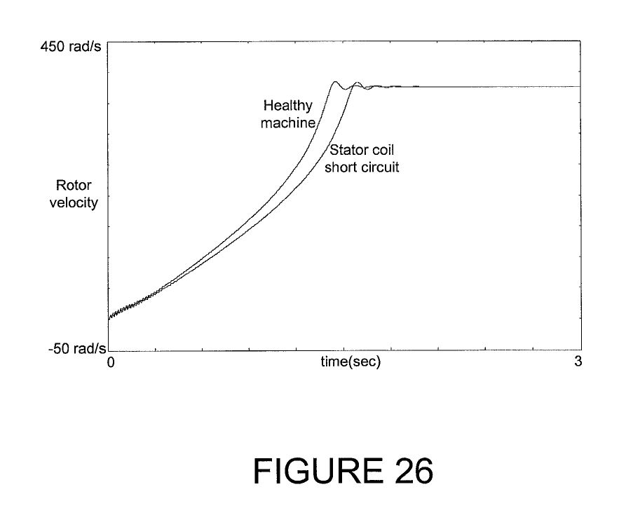

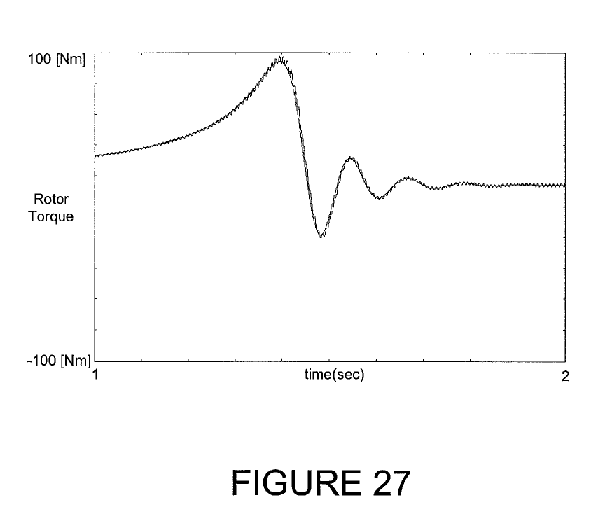

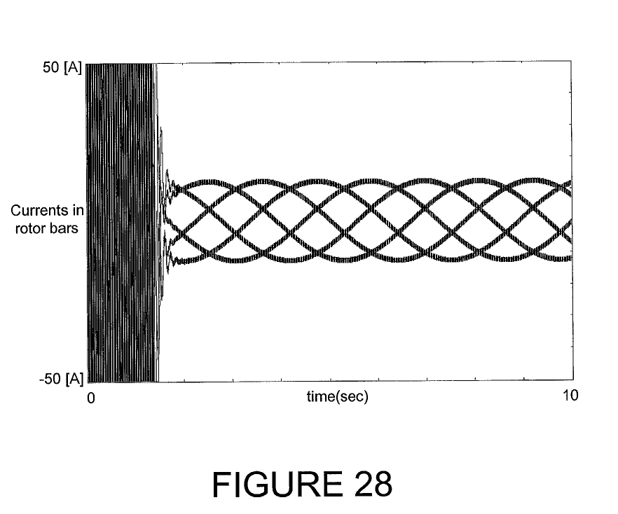

Simulations of an induction motor with a short circuited stator coil are shown in FIG. 26˜28. In these simulations, the resistance of the shorted coil decreases, and the coil current, the magnetic fields, and the induced currents in the rotor bars also change. FIG. 26 shows a difference in rise time of rotor velocity between the healthy machine and the stator coil short-circuited machine. FIG. 27 shows the rotor torque for both healthy and shorted machines. The overall trend of the torques are similar, but there exists small amplitude and relatively high frequency oscillations in the short-circuit case. These oscillations are also seen in the rotor bar currents, FIG. 28, compared with the rotor bar currents of the healthy machine, shown in FIG. 16.

A bond graph model of a squirrel cage induction motor was constructed, based on a prior bond graph by Ghosh and Bhadra (1993), that exhibited a one-to-one correspondence between the bond graph elements and real system components. Included were stator coil windings for three phases, mathematical transformations to incorporate two reaction theory, magnetic state variables to represent magnetic interactions between stator and rotor, individual rotor bars and contributions to the total rotor torque and velocity, and mechanical inertias and resistances. The simulations in this article had five rotor bars. Using this model, simulations of a healthy machine were compared to simulations of machines with a broken rotor bar breakage and a shorted stator coil. The degraded machine simulations predicted oscillations in currents and angular velocities, seen in real motors.

Most induction motor designs employ three phase excitation of the stator. For a rotor with more bars, the bond graph of FIG. 15 can be easily altered. More rotor bars can be included in FIG. 15 by adding additional pairs of power pathways to the right of the 2-port C's, such that n power pathways fan out from both α and β rotor phases. For the new value of n, these power pathways must update equations (11) and (12) governing moduli mrₖ for the modulated transformers MTF:mrₖ and equation (18) governing modulus rₖ of the modulated gyrators MGY:rₖ. To update the electromechanical torque, in equation (17) we must replace the 5 in the upper index of the sum and the square root argument in the denominator with the new value of n.

A Second Exemplary Application

This subsection refers to equations 1-6 in the detailed description. In addition, the remaining equation numbers refer to equations within this subsection. Further, an appendix is attached which is referenced in this subsection.

In a further embodiment of an induction motor, the bond graph model of a squirrel cage induction motor from above is adjusted. This model includes stator windings for 3 phases, two-reaction theory, magnetic interactions between stator and rotor, individual rotor bar contributions to rotor torque and velocity, mechanical inertias, and resistances and losses. Although this model does not include certain critical phenomena of the induction motor—e.g., magnetic field with rotor eccentricity or rotor dynamics—this model is simple and can illustrate how to apply Shannon's communication theory to machine systems.

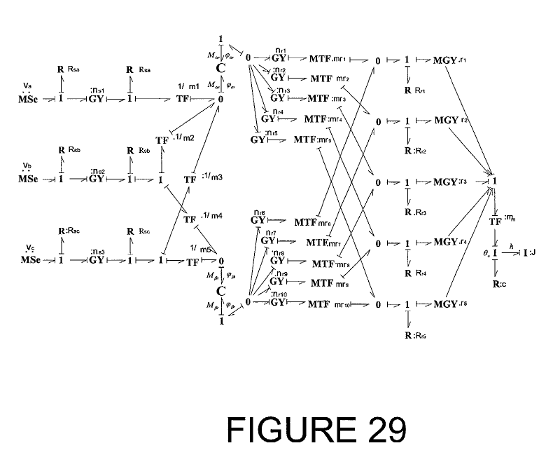

In the system shown in FIG. 29, MSe:Vₐ, MSe:V_{b} and MSe:V_{c} indicate the 3-phase alternating voltage applied to the motor. The resistor element R:Rₛ models resistive losses in the stator windings of the motor. The gyrator GY:nₛ models the transition from the electric to the magnetic domain of the power flow in the system. The modulus of the gyrator nₛ equals the number of turns of the stator coil. The battery of transformers TF:mₖ convert the 3-phase into a rotating phasor vector. The two-port capacitance elements C represent the interaction between stator and rotor fields.

In the rotor, electric voltage is induced in the metal bars by time varying flux cutting the bar circuits. This represented as the battery of gyrators, which have moduli nᵣ related to the number of turns of the rotor. The modulated transformers MTF:mrₖ relate angular position of the rotor relative to the flux field. The resistor elements R:Rᵣ represent resistive losses in the rotor circuits. Modulated gyrators MGY:rₖ convert bar currents on the rotor bars into torque; this is the magneto-mechanical interaction. The moduli for these gyrators depend on fluxes in the rotor. The final transformer TF:mₘ is related to the number of magnetic poles in the system. Power lost by bearing friction is accounted for by the resistance R:c. The remainder of the power drives the output shaft.

Moduli in the Bond Graph (FIG. 29) are Given as Follows [6]:

1) Moduli of three phases are (mₖ)

$${m}_{1} = \sqrt{\frac{2}{3}} , {m}_{2} = {m}_{3} = - \frac{1}{\sqrt{6}} , {m}_{4} = \frac{1}{\sqrt{2}} , {m}_{5} = - \frac{1}{\sqrt{2}} \qquad ( 7 )$$

2) Constitutive laws for two port C fields are:

$$[ \begin{matrix}{M}_{ls} \\ {M}_{lr}\end{matrix} ] = [ \begin{matrix}{ℛ}_{s} & - {ℛ}_{m} \\ - {ℛ}_{m} & {ℛ}_{r}\end{matrix} ] [ \begin{matrix}{ϕ}_{ls} \\ {ϕ}_{lr}\end{matrix} ] \qquad ( 8 )$$

where, i=α, β and

$${ℛ}_{s} = \frac{{n}_{s}^{2} {L}_{r}}{{L}_{s} {L}_{r} - {L}_{m}^{2}} , {ℛ}_{m} = \frac{{n}_{s} {n}_{r} {L}_{m}}{{L}_{s} {L}_{r} - {L}_{m}^{2}} , {ℛ}_{r} = \frac{{n}_{r}^{2} {L}_{s}}{{L}_{s} {L}_{r} - {L}_{m}^{2}} ,$$

Lₛ is stator self inductance, Lₘ is mutual inductance and Lᵣ is rotor self inductance. The gyrator moduli nₛ is the number of stator coil turns, and gyrator moduli nᵣ is the number of rotor coil turns.

3) The modulated transformers MTF:mrₖ are:

$$\begin{matrix}{mr}_{k} = \sqrt{\frac{2}{n}} cos \{ θ + \frac{2 ( k - 1 ) π}{n} \} & k = 1 , 2 , … , n \\ {mr}_{k + n} = \sqrt{\frac{2}{n}} sin \{ θ + \frac{2 ( k - 1 ) π}{n} \} & with n = 5\end{matrix} \qquad ( 9 )$$

where n is the total number of bars.

4) The moduli of the modulated gyrators MGY:rₖ are:

rₖ=nᵣ└φ_{βr}mrₖ−φ_{αr}mrₖ₊ₙ┘ k=1,2, . . . , n (10)

5) The modulus for transformer TF:mₘ is:

$${m}_{m} = \frac{{P}_{p}}{2} \text{:} {P}_{p} is number of poles \qquad ( 11 )$$

Pₚ is number of poles (11)

State equations were derived from the bond graph (FIG. 29) with n_{S1}=nₛ₂=nₛ₃=nₛ, nᵣ₁=□=nᵣ₁₀=nᵣ. The results of state equations are

$$\begin{matrix}{\dot{θ}}_{o} = \frac{1}{{m}_{m}} \frac{h}{J} & ( 12 ) \\ \begin{matrix}{\dot{ϕ}}_{α r} = - ( {mr}_{1}^{2} {R}_{r1} + {mr}_{2}^{2} {R}_{r2} + {mr}_{3}^{2} {R}_{r3} + {mr}_{4}^{2} {R}_{r4} + \\ {mr}_{5}^{2} {R}_{r5} ) \frac{{M}_{α r}}{{n}_{r}^{2}} - ( {mr}_{1} {mr}_{6} {R}_{r1} + {mr}_{2} {mr}_{7} {R}_{r2} + \\ {mr}_{3} {mr}_{8} {R}_{r3} + {mr}_{4} {mr}_{9} {R}_{r4} + {mr}_{5} {mr}_{10} {R}_{r5} ) \frac{{M}_{β r}}{{n}_{r}^{2}} - \\ ( {mr}_{1} \cdot {r}_{1} + {mr}_{2} \cdot {r}_{2} + {mr}_{3} \cdot {r}_{3} + {mr}_{4} \cdot {r}_{4} + {mr}_{5} \cdot \\ {r}_{5} ) \frac{1}{{n}_{r} \cdot {m}_{m}} \frac{h}{J}\end{matrix} & ( 13 ) \\ \begin{matrix}{\dot{ϕ}}_{β r} = - ( {mr}_{6}^{2} {R}_{r1} + {mr}_{7}^{2} {R}_{r2} + {mr}_{8}^{2} {R}_{r3} + {mr}_{9}^{2} {R}_{r4} + \\ {mr}_{10}^{2} {R}_{r5} ) \frac{{M}_{β r}}{{n}_{r}^{2}} - ( {mr}_{1} {mr}_{6} {R}_{r1} + {mr}_{2} \cdot {mr}_{7} {R}_{r2} + {mr}_{3} \cdot \\ {mr}_{8} {R}_{r3} + {mr}_{4} \cdot {mr}_{9} {R}_{r4} + {mr}_{5} \cdot {mr}_{10} {R}_{r5} ) \frac{{M}_{α r}}{{n}_{r}^{2}} - ( {mr}_{6} \cdot {r}_{1} + \\ {mr}_{7} \cdot {r}_{2} + {mr}_{8} \cdot {r}_{3} + {mr}_{9} \cdot {r}_{4} + {mr}_{10} \cdot {r}_{5} ) \frac{1}{{n}_{r} \cdot {m}_{m}} \frac{h}{J}\end{matrix} & ( 14 ) \\ \begin{matrix}{\dot{ϕ}}_{αs} = \frac{1}{{m}_{1} \cdot {n}_{s}} ( ( 1 - \frac{{R}_{s1}^{2}}{{n}_{s}^{2} + {R}_{s1}^{2}} ) {V}_{a} - \frac{{n}_{s} \cdot {R}_{s1}}{{n}_{s}^{2} + {R}_{s1}^{2}} \frac{1}{{m}_{1}} {M}_{α s} ) + \\ \frac{1}{{m}_{2} \cdot {n}_{s}} ( ( 1 - \frac{{R}_{s2}^{2}}{{n}_{s}^{2} + {R}_{s2}^{2}} ) {V}_{b} - \frac{{n}_{s} \cdot {R}_{s2}}{{n}_{s}^{2} + {R}_{s2}^{2}} ( \frac{1}{{m}_{2}} {M}_{α s} + \\ \frac{1}{{m}_{4}} {M}_{β s} ) ) + \frac{1}{{m}_{3} \cdot {n}_{s}} ( ( 1 - \frac{{R}_{s3}^{2}}{{n}_{s}^{2} + {R}_{s3}^{2}} ) {V}_{c} - \\ \frac{{n}_{s} \cdot {R}_{s3}}{{n}_{s}^{2} + {R}_{s3}^{2}} ( \frac{1}{{m}_{3}} {M}_{α s} + \frac{1}{{m}_{5}} {M}_{β s} ) )\end{matrix} & ( 15 ) \\ \begin{matrix}{\dot{ϕ}}_{β s} = \frac{1}{{m}_{4} \cdot {n}_{s}} ( ( 1 - \frac{{R}_{s2}^{2}}{{n}_{s}^{2} + {R}_{s2}^{2}} ) {V}_{b} - \frac{{n}_{s} \cdot {R}_{s2}}{{n}_{s}^{2} + {R}_{s2}^{2}} ( \frac{1}{{m}_{2}} {M}_{α s} + \\ \frac{1}{{m}_{4}} {M}_{β s} ) ) + \frac{1}{{m}_{5} \cdot {n}_{s}} ( ( 1 - \frac{{R}_{s3}^{2}}{{n}_{s}^{2} + {R}_{s3}^{2}} ) {V}_{c} - \\ \frac{{n}_{s} \cdot {R}_{s3}}{{n}_{s}^{2} + {R}_{s3}^{2}} ( \frac{1}{{m}_{3}} {M}_{α s} + \frac{1}{{m}_{5}} {M}_{β s} ) )\end{matrix} & ( 16 ) \\ \begin{matrix}\dot{h} = ( {r}_{1} \cdot {mr}_{1} + {r}_{2} \cdot {mr}_{2} + {r}_{3} \cdot {mr}_{3} + {r}_{4} \cdot {mr}_{4} + {r}_{5} \cdot \\ {mr}_{5} ) \frac{1}{{m}_{m} \cdot {n}_{r}} {M}_{α r} + ( {r}_{1} \cdot {mr}_{6} + {r}_{2} \cdot {mr}_{7} + {r}_{3} \cdot {mr}_{8} + {r}_{4} \cdot {mr}_{9} + \\ {r}_{5} \cdot {mr}_{10} ) \frac{1}{{m}_{m} \cdot {n}_{r}} {M}_{β r} - \frac{h}{J} c\end{matrix} & ( 17 )\end{matrix}$$

where the magnetic state variables are rotor angular position θₒ and momentum h and stator and rotor phase fluxes φ_{αs}, φ_{βs}, φ_{αr} and φ_{βr}.

Simulation of a squirrel cage induction motor employed MATLAB®'s Runge-Kutta 4^{th} order method with a time step δt=10⁻⁵ seconds. Values of the system parameters presented in Table 2 were given by Kim and Bryant [6, 7].

Using this model, simulations were performed for an ideal machine, which has no faults and functions perfectly according to designer's specifications, and a degraded machine. The ideal machine will serve as a reference of desired dynamic behavior. The degraded motor will exhibit common degradation modes, including rotor bar breakage and stator coil shorts. We will excite the ideal and degraded machine models with identical test signals, record these signals, and then estimate the noise as the difference between degraded and ideal machine responses to the same test signal.

TABLE 2
System parameters of a two pole, three phase squirrel cage induction motor.

| Parameter | Description | Ideal | Degraded |
|---|---|---|---|
| Rₛₐ, R_{sb}, R_{sc} | Stator coil resistance [Ω] | 0.0788 | 0.00079-0.0709 |
| Rᵣ₁, . . ., Rᵣ₁₀ | Rotor bar resistance [Ω] | 0.0408 | 0.0412-4.0800 |
| Vₐ, V_{b}, V_{c} | Input voltage amplitude [V] | 230 | — |
| f | Input voltage frequency [Hz] | 60 | — |
| Rₛ | Stator Reluctance [1/H] | 5.85 × 10⁶ | — |
| Rᵣ | Rotor Reluctance [1/H] | 563 | — |
| Rₘ | Mutual Reluctance [1/H] | 5.41 × 10⁴ | — |
| n | Number of rotor bars | 5 | — |
| nₛ | Number of effective stator coil turns | 100 | 1-90 |
| nᵣ | Number of effective rotor coil turns (bar) | 1 | — |
| c | Mechanical resistance [N · s/m] | 0.15 | — |
| J | Mechanical inertia [kg · m²] | 0.1 | — |
| mₘ (=Pₚ/2) | Number of poles □ 2 | 2 | — |

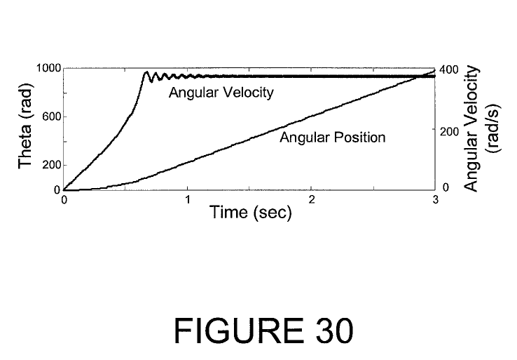

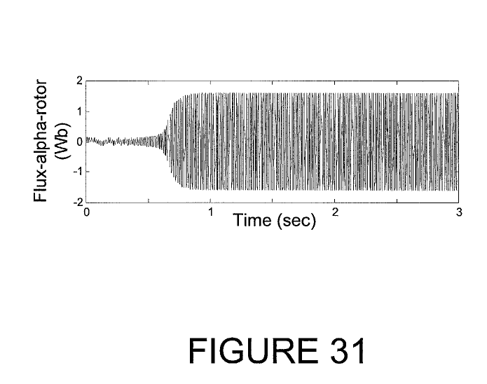

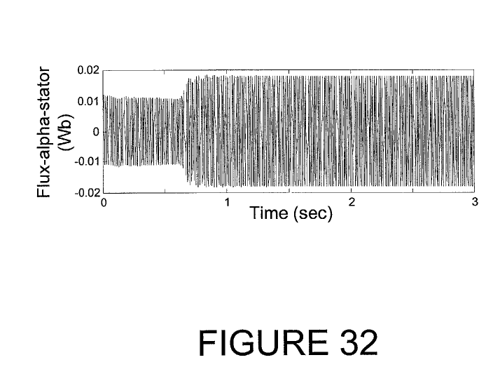

FIG. 30˜32 show sample simulation results for a nominal or ideal motor, i.e., a motor without faults. These simulations arose from the model of equations (7) to (17), with the “Ideal” parameter values of Table 2. Plotted are selected motor state variables versus time, beginning with motor startup, i.e. the motor voltages were switched “on”. The rotor velocity rises slowly to a steady state value of about 377 rad/sec, as the momentum and all other state variables reach steady state. Theoretically, when 60 Hz alternating inputs are given to a two pole AC motor, the output velocity should be close to 3600 RPM (≅377 rad/sec). Rotor and stator fluxes of α phases are shown in FIGS. 31 and 32; the β fluxes are similar. Flux amplitudes increase to steady state, consistent with the angular velocity.

Various faults can be developed in motors. For example, stator coil shorts cause overheating, increasing core losses [8]; rotor bar breaks or cracks in the die-cast rotors cause very large electrical resistance [6, 7, 9]; and bent or cracked shafts make the rotation wobble [10].

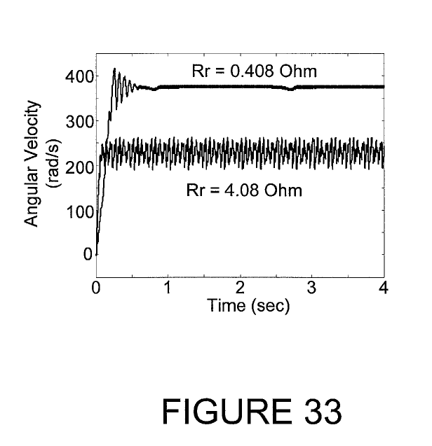

In this article, we will focus on a broken rotor bar, and shorted stator coils. When rotor bars break, steady state velocity and torque of the rotor will deviate from the ideal response. With the bond graph shown in FIG. 29, a broken bar can be incorporated into the model by increasing selected rotor bar resistances Rᵣ. The range of deviation is given in Table 2, last column. FIG. 33 (upper curve) shows the response of the motor with a broken bar after being switched “on”. In this case, the rotor bar resistance was increased 10 times from its nominal value of 0.0408 □, ohms, to Rᵣ=0.408 □.ohms. Plotted is the angular velocity versus time, from start up. Here the angular velocity increases, during a transient time characterized by deviations of rotor velocity.

FIG. 33 (bottom curve) shows the simulated startup (step) response for a motor with a rotor bar having resistance increased 100 times, to Rᵣ=4.08 □.ohms. This curve shows increased and persistent oscillations, compared to FIG. 30 for the ideal machine.

It is well established that when rotor faults occur, rotor harmonic fluxes are produced which induce currents in the stator at frequencies of f└k/(Pₚ/2)·(1−s)−s┘. Here f is the supply frequency, Pₚ is the number of poles, k=1,2,3,4 . . . , and s is slip defined as [11, 12]

$$s = \frac{{ω}_{s} - {ω}_{r}}{{ω}_{s}} . \qquad ( 18 )$$

In equation (18) ωₛ is the synchronous speed derived from the frequency of the stator currents, and ωᵣ is the angular speed of the rotor. Slip can have a value from 0 to 1.

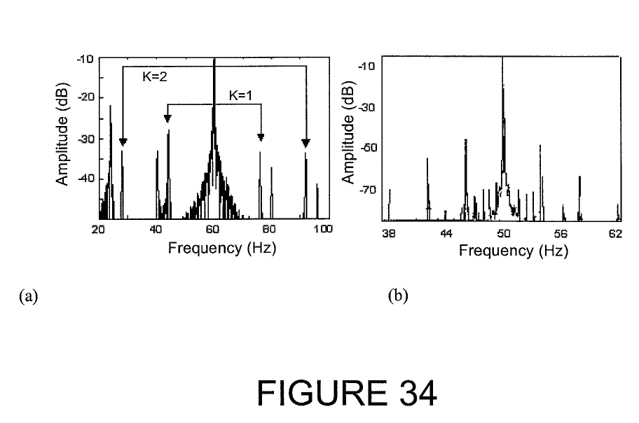

FIG. 34(a), constructed by applying a Fourier transform to the steady state portion of the simulation results of FIG. 33 (bottom curve), shows some frequencies of the stator current of phase A in the vicinity of the excitation frequency (60 Hz). FIG. 34(b), scanned from reference [13], shows spectral densities of typical currents versus frequency measured from a motor with three broken bars. Comparison of FIG. 34(a) and (b) show similar shape and location of spectral peaks.

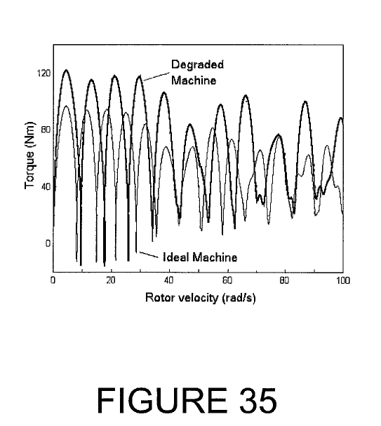

FIG. 35 compares the torque characteristic of the ideal machine and broken bar machine Rᵣ=0.408 □.ohms. The rotor torque oscillates whenever the rotor velocity oscillates. Due to the rotor asymmetry the level of pulsating torque is increased [6, 12].

The average power in a signal x(t), of duration T can be estimated as [14]

$$S = P \{ x ( t ) \} = \frac{1}{T} {\int }_{0}^{T} {[ x ( t ) ]}^{2} ⅆ t \qquad ( 19 )$$

or as

$$S ≐ \frac{1}{N} {\sum }_{n = 0}^{N - 1} {x}_{n}^{2} . \qquad ( 20 )$$

If xₙ is a sequence sampled from x(t) at equally spaced discrete instants. The power spectral density, the magnitude squared of the Fourier transform of x(t), is given by

S(f)=|X(f)|² (21)

Where

$$X ( f ) = {\int }_{- ∞}^{∞} x ( t ) {ⅇ}^{- jω t} ⅆ t .$$

For discrete xₙ, we employed a fast Fourier transform to obtain Xₖ.

The total power can be calculated in the frequency domain, or in the time domain by Parseval's theorem. [14]

$${\int }_{- ∞}^{∞} {\vert x ( t ) \vert}^{2} ⅆ t = {\int }_{- ∞}^{∞} {\vert X ( f ) \vert}^{2} ⅆ f \qquad ( 22 )$$

The discrete form of Parseval's theorem is defined as [14]

$${\sum }_{n = 0}^{N - 1} {\vert {x}_{n} \vert}^{2} = \frac{1}{N} {\sum }_{k = 0}^{N - 1} {\vert {X}_{k} \vert}^{2} . \qquad ( 23 )$$

Equation (5) can be rewritten as

$$C = {\int }_{0}^{ω} \{ {log}_{2} ( S + N ) - {log}_{2} N \} ⅆ ω . \qquad ( 24 )$$

Combination of the original signal power spectral density (S) and the noise power spectral density (N) represents the signal power spectral density

S_{*}=S+N (25)

from the degraded machine.

Shannon [1] assumed a Gaussian white noise statistically independent of the signal. To remove this restriction, we need to calculate the noise power directly from the time domain signals. In the time domain, the noise is defined as the difference between actual and ideal signals

n(t)=x(t)−xₒ(t). (26)

Here x(t) is the output of the degraded machine, and xₒ(t) is the output of the ideal machine. As demonstrated in the Appendix for this subsection, removal of the independence restrictions between signal and noise admits negative channel capacities.

Power spectral densities S_{*}′ and N′ can be defined as the magnitude squared of the Fourier transforms for signal x(t) and noise n(t) respectively. To calculate the channel capacity with these values, we must replace (S+N) in equation (24) with S_{*}′, and N with N′ to have

$$C = {\int }_{0}^{ω} \{ {log}_{2} ( \frac{{S}_{*}^{′}}{{N}^{′}} ) \} ⅆ ω . \qquad ( 27 )$$

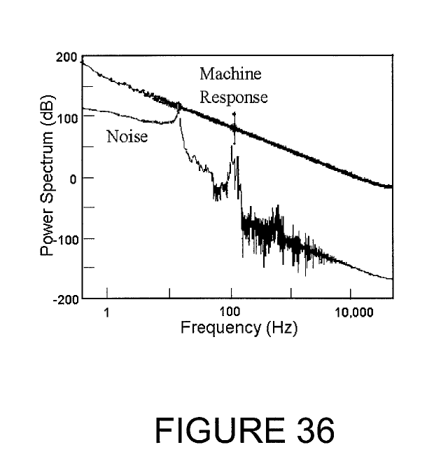

FIG. 36 (upper line) shows the power spectrum of the rotor velocity of the ideal machine as shown in FIG. 30 (upper line), and defined in section 4.1. This figure was constructed by applying a fast Fourier transform to the angular velocity data of FIG. 30 (upper line). In this case, we assume zero noise, and thus the system functions perfectly, according to the design specifications. Using equation (27), we get an infinite channel capacity for an ideal machine system, since by definition, the noise and noise power are zero.

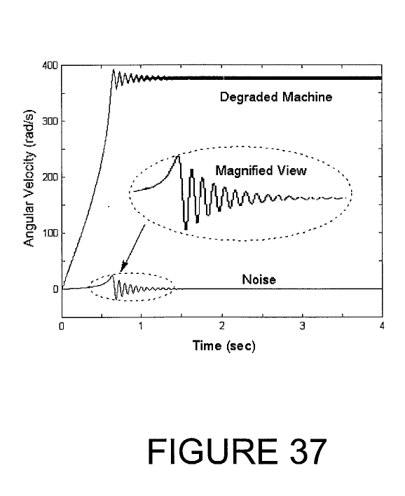

If there are faults such as broken rotor bars as mentioned in section 4.2 earlier, the power spectrum will change as noise contaminates the signal. FIG. 37 shows the startup response x(t) of the machine with a broken bar (upper line), and the noise in the time domain from the degraded machine, defined by equation (26). This noise (lower curve and magnified in FIG. 37) is the difference between the degraded machine's response curve in FIG. 37, and the startup response of the ideal machine in FIG. 30. The presence of several frequencies is evident. FIG. 36 (dots in the upper line) shows the power spectra (signals and noise) of a degraded machine, with a cracked rotor bar. Note that the power spectrum of the degraded machine signal x(t) nearly overlaps the power spectrum of the ideal machine signal xₒ(t); in the figure, the two almost coincide. In our model, we increased the resistance of broken (cracked) bar by 10%. Using equation (27), we obtained a channel capacity of 1.1×10⁶ (bits per second). Here the integration bandwidth ω in equation (27) was equated to the entire sampling bandwidth (5×10⁴ Hz) based on the Nyquist's sampling rate, where δt=10⁻⁵ seconds was the time step employed in the numerical solution routine. In this procedure, we viewed the numerical solution's data points as a “sampled” signal, with sampling interval equal to the numerical method's time step. The Nyquist's sampling rate gives the smallest bandwidth associated with the sampling interval δt=10⁻⁵ seconds.

In equation (6) for entropy rate R, Sᵢ represents the average power of the output signal from the healthy machine and Nᵢ represents the largest acceptable deviation, i.e., a tolerance on the noise. The signal bandwidth (ωᵢ) was equated to ω; see the previous paragraph for justification. The functional requirements of the machine determine the noise or error tolerance Nᵢ demanded by the machine to work satisfactorily. For example, if we have an application wherein the maximum allowed error or tolerance must be within 10% of the signal of the ideal machine, and if we employ the same bandwidth as for the channel capacity, then from the equations (6) and (19), the information rate (R) is

$$R = {ω}_{i} {log}_{2} ( {S}_{i} / {N}_{i} ) = 5 \times {10}^{4} {log}_{2} ( \frac{\frac{1}{T} \int {\vert x ( t ) \vert}^{2} ⅆ t}{\frac{1}{T} \int {\vert 0.1 \times x ( t ) \vert}^{2} ⅆ t} ) = 3.3 \times {10}^{5} \text{(bits per second)} \qquad ( 28 )$$

With a channel capacity of 1.1×10⁶ (bits per second), the result for R above satisfies the condition of R≦C. This suggests a still “healthy” machine.

If the resistance of the broken bar increases 21 times to Rᵣ=0.8568□, then the channel capacity drops to 2.4×10⁵ (bits per second) below the required (R) of 3.3×10⁵ (bits per second). Since this result doesn't satisfy R≦C, according to Shannon's theorem, the machine is malfunctioning. As the magnitude of the fault (bar resistance) increases, the channel capacity diminishes.

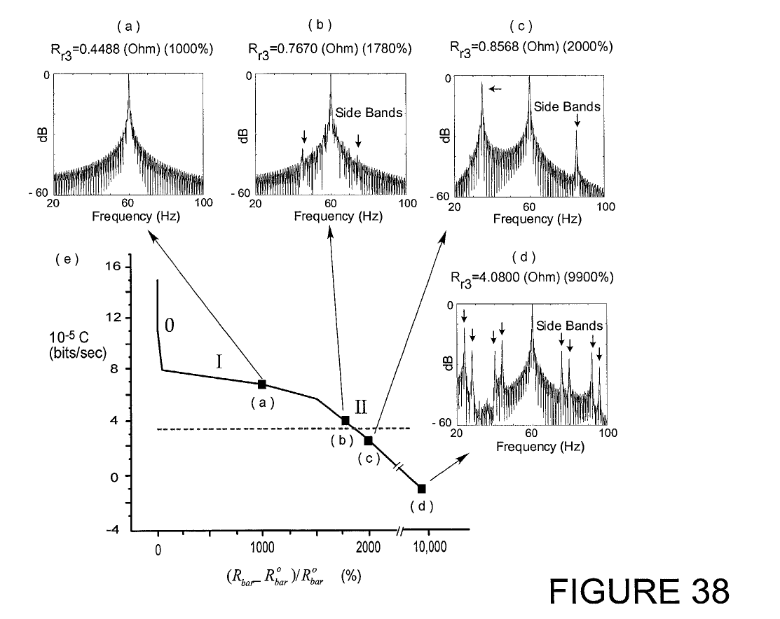

FIGS. 38(a)-38(d), show selected power spectral densities of the stator current of phase A at steady state, for selected bar resistances. These figures are similar to FIG. 34(a) and are often used as diagnostic indicators. Side bands are absent for smaller values of Rᵣ, but start to appear after the rotor bar resistance equals approximately 0.7670□ohms (1780%). FIG. 38(e) also plots the channel capacities versus the percent change of bar resistance from the ideal value given by table 2. The dashed line indicates the 10% noise power tolerance (R=3.3×10⁵) estimated in the previous paragraph. Here percent change is defined as % R_{bar}=(R_{bar}−R_{bar}⁰)/R_{bar}⁰, where R_{bar} is the current value, and R_{bar}⁰ the ideal. The channel capacity of point (d) in FIG. 38(e) has a negative value; see the Appendix for reasons. As shown in FIGS. 38(c) and 38(d), significant side bands with large intensity begin to appear in the power spectra, wherever the channel capacity curve sinks below the 10% information rate line (dashed curve). From a practical standpoint, for industrial grade rugged machines such as motors, we would begin to notice errors when these exceed 10% or more in the motor's output velocity. Thus, 10% was chosen as the critical velocity condition.

The curve of FIG. 38(e) can be separated into regions with three distinct slopes: region 0, which connects the infinite channel capacity of the ideal system to that of “real” systems; region I, with stable C and “healthy” operation (region I would be associated with the normal life cycle operating region of the system); and region II, where C declines to the (dashed) failure line. Note that the marked change in the slope of C or the rapidly diminishing values of C, going from region I to II, could presage failure. FIGS. 38(b)-(d) suggest that once side bands appear, the slope of C becomes noticeably more negative.

Signal based diagnostic methods, that trigger upon detection of side bands, at earliest would notice the broken bar fault at point (b) in FIG. 38(e); FIG. 38(b) suggests that detection of the tiny side band would be difficult. In contrast, the channel capacity curve's knee—where the slope abruptly changes—occurs at 1500%, before 1780% of FIG. 38(b). Here the abrupt change in slope might be easier to detect.

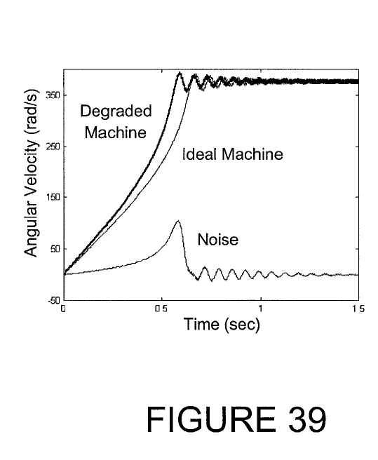

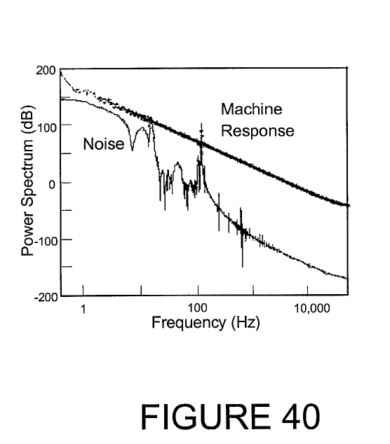

Simulation of an induction motor with short circuited turns on its stator coil is shown in FIG. 39. Here stator resistance Rₛ₁ of phase A was decreased 50%, and the effective number of turns represented by gyrator modulus nₛ was similarly decreased from 100 to 50. In this simulation, only one of the stator coils has shorted turns. In the model and physically, as turns are short circuited, the resistance in that coil decreases, and the effective number of turns also decreases. FIG. 40 shows the various signal and noise power spectra of this shorted machine. Note again that the power spectra of the ideal and degraded machines nearly coincide. The shorted coil seems to affect the angular velocity relatively less than a broken bar. The two startup responses in the FIG. 39 are nearly the same, especially at steady state. Essential differences at steady state are in the signal's phase, generally not contained in power spectra. By taking the difference between degraded and ideal response, the information on phase differences is conveyed in the noise power spectrum, in addition to the magnitude information.

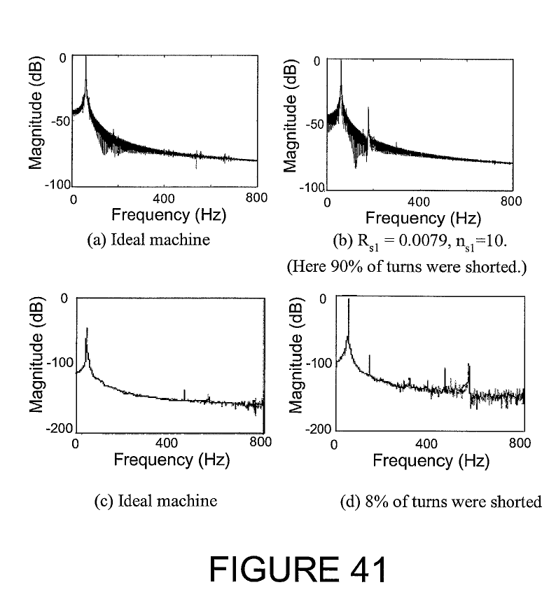

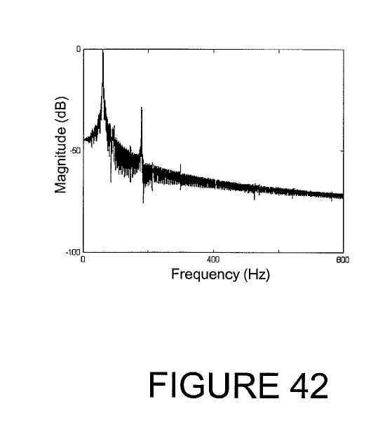

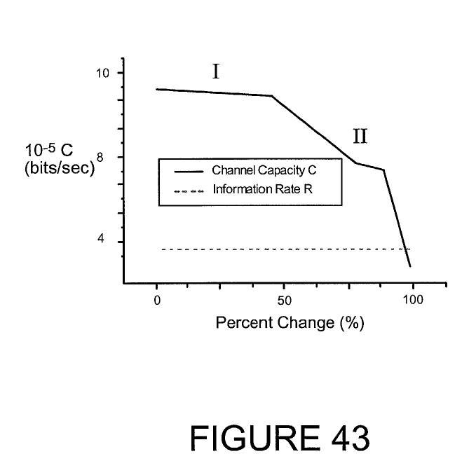

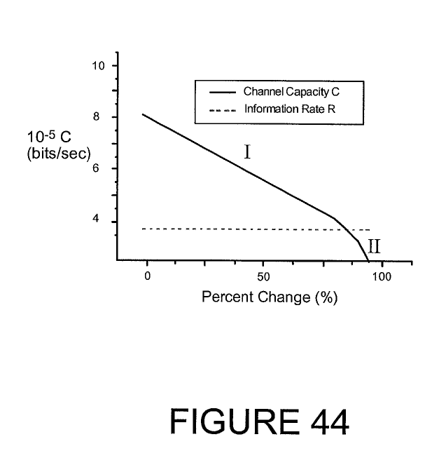

When stator coil turns short out, we observe only a rise in some of the frequency components which already exist in the stator current spectra of an ideal machine [15]. FIGS. 41(a) and (b) shows spectral content of the steady state stator current of phase A, from simulations of the bond graph model. For comparison, spectra from Gojko and Penman's model [15] are also shown as FIGS. 41(c) and (d). FIG. 42 shows spectral content of stator currents for two shorted coils, phases A and B. In FIGS. 43 and 44 are plotted the channel capacities versus percent change in the coil resistance, for shorting of phases A, and A and B, respectively. Again information rate for the 10% noise level on angular velocity is shown as the dashed line.

Similar to the broken bar case of FIG. 38, FIG. 43 exhibits a “healthy” region I, with stable channel capacity, and a region II with sharply diminishing channel capacity. Again the sharply changed slope of region II could prognose failure.

In this article, it was demonstrated how Shannon's theory of communication could be applied to machinery, to utilize Shannon's powerful theorems. Concepts of rate of information rate and channel capacity were reviewed, and applied to an induction motor. At the heart of the method is machine “noise”, estimated as the difference between actual and ideal responses. By subtracting the ideal response xₒ(t) from the actual response x(t), the noise signal contains only information about the faults. From the noise and signal were calculated power spectra, used in equation (27) for channel capacity. Rate R from equation (28) serves as a critical values dependent on the system's tolerance to errors, here called “noise”. The channel capacity was calculated for a motor with shorted stator coils and broken bars. The channel concept agreed with other existing fault monitoring methods, but results suggest that it could detect faults much earlier. It can be concluded from this study that the channel capacity concept could serve as an effective discriminator of motor and machine system health.

It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one, skilled in the art after having the benefit of this description of the invention. Changes may be made in the elements described herein without departing from the spirit and scope of the invention as described in the following claims.

As such, a method for diagnosing the state of a system is described. In view of the above detailed description of the present invention and associated drawings, other modifications and variations will now become apparent to those skilled in the art. It should also be apparent that such other modifications and variations may be effected without departing from the spirit and scope of the present invention as set forth in the claims which follow.

Nomenclature

C channel capacity

c viscous resistance coefficient

f supply frequency

H information entropy

h angular momentum [N·m·sec]

J moment of inertia

Ls, Lm, Lr stator self inductance, mutual inductance and rotor self inductance

M_{α}, M_{β} α and β axis magneto motive force m₁˜m₅ moduli of three phases

n modulus of gyrator (number of coil turns)

nₛ number of effective stator coil turn

nᵣ number of effective rotor coil turn

n(t) noise in time domain

Pₚ number of poles

p probability of occurrence

R entropy rate

Rs, Rr stator and rotor resistances

r₁˜r₅ modulated gyrator moduli of rotor

[symbol] ₛ, [symbol] ₘ, [symbol] ᵣ stator reluctance, mutual reluctance, rotor reluctance

S, N average power of the signal and noise

S_{*} average power of the signal including noises

s slip

Vₐ, V_{b}, V_{c} sinusoidal input voltages

x(t) output of the degraded machine in time domain

xₒ(t) output of the ideally healthy machine in time domain

ω bandwidth

φ_{α}, φ_{β} α and β axis fluxes

□ flux linkage

V_{αs}, V_{βs} α and β axis stator voltages

i_{αs}, i_{βs} α and β axis stator currents

i_{αr}, i_{βs} α and β axis rotor currents

Rₛ, Rᵣ stator and rotor resistances

Lₛ, Lₘ, Lᵣ stator self inductance, mutual inductance and rotor self inductance

Tₑ, T_{L} electromagnetic torque and mechanical load torque

J moment of inertia

c viscous resistance coefficient

ωᵣ, ωₘ electrical and mechanical angular velocities of the rotor

P number of pole pairs

λ flux linkage

m₁˜m₅ moduli of transformers for 3 phase to 2 phase transformation

Vₐ, V_{b}, V_{b} sinusoidal input voltages

m₁˜m₅ transformer moduli

iᵣₖ current in the k^{th} rotor bar,

m magnitude modulus that depends on the total number of bars

n modulus of gyrator (number of coil turns)

φ magnetic flux [Weber (Wb)]

M magneto motive force [Ampere (A)]

[symbol] permeance of circuit element [Henry (H)]

R reluctance of circuit element [1/Henry (H⁻¹)]

eₗ,e₂ effort

fₗ,f₂ flow

nₛ number of effective stator coil turn

nᵣ number of effective rotor coil turn

h: angular momentum [N·m·s=kg·m²·sec]

Rs_alpha,

Rs_beta,

Rₛ, Rsa,

Rsb, Rsc, R electrical resistances

### REFERENCES

These references are cited to provide a more detailed background. They are not considered necessary to enable the invention described herein.

[A] Control Lab Products B.V., 20-SIM Reference Manual, University of Twente, Enschede, Netherlands.

[B] Ghosh, B. C., and Bhadra, S. N., 1993, “Bond Graph Simulation of a Current Source Inverter Driven Induction Motor (Csi-In) System”, Electric Machines and Power Systems, Vol. 21, No. 1, pp. 51-67.

[C] Gradshteyn, I. S. and Ryzhik, I. M., 1980, Table of Integrals, Series, and Products, Academic Press, New York, 1980, pp. 29.

Hancock, N. N., 1974, Matrix Analysis of Electrical Machinery, 2nd Edition, Pergamon Press, New York.

[D] Krause, P. C., and Wasynezuk, O., 1989, Electromechanical Motion Devices, McGraw-Hill, N.Y., pp.183-184.

[E] Lawrie, R. J., 1987, Electric Motor Manual: Application, Installation, Maintenance, Troubleshooting, McGraw-Hill, N.Y.

[F] Manolas S T., and Tegopolous, J. A. 1997, “Analysis of Squirrel Cage Induction Motors with Broken Bars and Rings”, IEEE International Electric Machines and Drives Conference (1st: 1997: Milwaukee, Wis.) May 18-21, 1997, Milwaukee, Wis., USA.

[G] McPherson, G., 1981, An introduction to Electrical Machines and Transformers, Wiley, N.Y.

[H] Pansini, A. J., 1989, Basics of Electric Motors: Including Polyphase Induction and Synchronous Motors, Prentice Hall, N.J., 1989.

[I] Park, R. H., 1929, Two-Reaction Theory of Synchronous Machines—Generalized Method of Analysis, Part I, AIEE Trans, Vol. 48, July 1929, pp. 719-727.

[J] Sahm, D. A., 1979, “Two-Axis Bond Graph Model of the Dynamics of Synchronous Electrical Machines, Journal of the Franklin Institute, Vol. 308(3), pp. 205-218.

[K] Strang, G., 1988, Linear Algebra and Its Applications, 3rd Edition, Harcourt Brace Jovanovich College Publishers.

[L] Traister, J. E., 1988, Handbook of Polyphase Motors, Englewood Cliffs, N.J.

[1] Shannon, C. E. and Weaver, W., 1948, “The mathematical Theory of Communication”, The University of Illinois Press, Illinois.

[2] Bryant, M. D., 1998, “Application of Shannon's Communication Theory to Degradation Assessment of Systems”, Proceeding of the ASME Congress, Vol. 72, No. 9, pp 1192-1201.

[3] Fish, P. J., 1994, “Electronic Noise and Low Noise Design”, McGraw-Hill, N.Y.

[4] Vergers, C. A., 1987, “Handbook of Electrical Noise Measurement and Technology”, 2^{nd} Edition, Tab Book, Inc.

[5] Engberg, J. and Larsen, T., 1995, “Noise Theory of Linear and Nonlinear Circuits”, Wiley and Sons, New York.

[6] Kim, J., 1999, “Bond Graph models of a squirrel-cage induction motor and a Layshaft gearbox for degradation analysis”, Master thesis, The University of Texas—Austin.

[7] Kim, J. and Bryant, M. D., 2000, “Bond Graph Model of a Squirrel Cage Induction Motor with Direct Physical Correspondence”, Journal of Dynamic Systems, Measurement, and Control, Vol. 122, pp 461-469.

[8] Traiser, J. E., 1992, “Handbook of Electric Motors: Use and Repair”, 2^{nd} Edition, The Fairmont Press. Inc.

[9] Smeaton, R. W., 1997, “Motor application and maintenance handbook”, 2^{nd} Edition, McGraw-Hill, N.Y.

[10] Edwards, S., Lees, A. W. and Friswell, M. I., 1998, “Fault Diagnosis of Rotating machinery”, Shock and Vibration Digest, Vol. 30, No. 1, pp 4-13.

[11] Kliman, G. B. and Stein, J., 1992, “Methods of Motor Current Signature Analysis”, Electric Machines and Power Sytems, Vol. 20, pp 463-474.

[12] Fiser, R. and Ferkolj, S., 1997, “Simulation of Steady-State and Dynamic Performance of Induction Motor for Diagnostic Purpose”, IEEE International Electric Machines and Drives Conference Record, pp WB3 10.1˜10.3.

[13] Watson, J. F., Paterson, N.C. and Dorrell, D. G., 1997, “Use of Finite Element Methods to Improve Techniques for the Early Detection of Faults in 3-phase Induction Motors”, IEEE International Electric Machines and Drives Conference Record, pp WB3 9.1˜9.3.

[14] Stremler, F. G., 1982, “Introduction to Communication Systems”, 2^{nd} Edition, Addison-Wesley Publishing Company

[15] Joksimovic, G. M. and Penman, J., 2000, “The Detection of Inter-Turn Short Circuits in the Stator Windings of Operation Motors”, IEEE Transactions on Industrial Electronics, Vol. 47, No.5, pp 1078-1084.

### APPENDIX FOR FIRST SQUIRREL CAGE INDUCTION MOTOR EXAMPLE

In this section, for a rotor with n bars, we prove

$$m = \sqrt{\frac{2}{n}} . \qquad \text{(A.1)}$$

From equations (15) and (16), the transformation matrix times its transpose is

$${A}^{T} A = m [ \begin{matrix}cos θ & cos ( θ + \frac{2 π}{n} ) & cos ( θ + \frac{4 π}{n} ) & ⋯ & cos ( θ + \frac{2 ( n - 1 ) π}{n} ) \\ sin θ & sin ( θ + \frac{2 π}{n} ) & sin ( θ + \frac{4 π}{n} ) & ⋯ & sin ( θ + \frac{2 ( n - 1 ) π}{n} )\end{matrix} ] \times m [ \begin{matrix}cos θ & sin θ \\ cos ( θ + \frac{2 π}{n} ) & sin ( θ + \frac{2 π}{n} ) \\ cos ( θ + \frac{4 π}{n} ) & sin ( θ + \frac{4 π}{n} ) \\ ⋮ & ⋮ \\ cos ( θ + \frac{2 ( n - 1 ) π}{n} ) & sin ( θ + \frac{2 ( n - 1 ) π}{n} )\end{matrix} ] \qquad \text{(A.2)}$$

The result of the multiplication is a square matrix of dimension 2,

$$\begin{matrix}{A}^{T} A = {m}^{2} [ \begin{matrix}{s}_{11} & {s}_{23} \\ {s}_{21} & {s}_{22}\end{matrix} ] \\ \text{where} & \text{(A.3)} \\ {s}_{11} = {\sum }_{k = 1}^{n} {cos}^{2} \{ θ + \frac{2 ( k - 1 ) π}{n} \} , \\ {s}_{12} = {s}_{21} = {\sum }_{k = 1}^{n} cos \{ θ + \frac{2 ( k - 1 ) π}{n} \} sin \{ θ + \frac{2 ( k - 1 ) π}{n} \} , \\ {s}_{22} = {\sum }_{k = 1}^{n} {sin}^{2} \{ θ + \frac{2 ( k - 1 ) π}{n} \} . & \text{(A.4)}\end{matrix}$$

Equations (A.4) can be rewritten using double angle trigonometric formulas:

$${s}_{11} = {\sum }_{k = 1}^{n} \frac{1 + cos \{ 2 θ + \frac{4 ( k - 1 ) π}{n} \}}{2} = \frac{n}{2} + \frac{1}{2} {\sum }_{j = 0}^{n - 1} cos \{ 2 θ + j \frac{4 π}{n} \} \\ {s}_{12} = \frac{1}{2} {\sum }_{k = 1}^{n} sin \{ 2 θ + \frac{4 ( k - 1 ) π}{n} \} = \frac{1}{2} {\sum }_{j = 0}^{n - 1} sin \{ 2 θ + j \frac{4 π}{n} \} \\ {s}_{22} = {\sum }_{k = 1}^{n} \frac{1 - cos \{ 2 θ + \frac{4 ( k - 1 ) π}{n} \}}{2} = \frac{n}{2} - \frac{1}{2} {\sum }_{j = 0}^{n - 1} cos \{ 2 θ + j \frac{4 π}{n} \} \qquad \text{(A.5)}$$

Via formulas 1.341-1 and 1.341-3 in Gradshteyn and Ryzhik (1980), the sums of sine and cosine terms on the right sides of equations (A.5) are zero, for n≧3. Thus

$$\begin{matrix}{s}_{11} = \{ \begin{matrix}\frac{1}{2} + \frac{1}{2} cos 2 θ ; & n = 1 \\ 1 + cos 2 θ ; & n = 2 \\ \frac{n}{2} ; & n \geq 3\end{matrix} & \text{(A.6)} \\ {s}_{22} = \{ \begin{matrix}\frac{1}{2} - \frac{1}{2} cos 2 θ ; & n = 1 \\ 1 - cos 2 θ ; & n = 2 \\ \frac{n}{2} ; & n \geq 3\end{matrix} & \text{(A.7)} \\ {s}_{12} = {s}_{21} = \{ \begin{matrix}\frac{1}{2} sin 2 θ ; & n = 1 \\ sin 2 θ ; & n = 2 \\ 0 ; & n \geq 3\end{matrix} & \text{(A.8)}\end{matrix}$$

Therefore, we can conclude

$${A}^{T} A = {m}^{2} [ \begin{matrix}{s}_{11} & {s}_{12} \\ {s}_{21} & {s}_{22}\end{matrix} ] = {m}^{2} [ \begin{matrix}\frac{n}{2} & 0 \\ 0 & \frac{n}{2}\end{matrix} ] = {m}^{2} \frac{n}{2} [ \begin{matrix}1 & 0 \\ 0 & 1\end{matrix} ] \qquad ( A .9 )$$

for the rotor with more than 2 rotor bars, i.e., n≧3.

### APPENDIX FOR SECOND EXAMPLE OF INDUCTION MOTOR

Range of Channel Capacity Values

In equation (27), average power of the output signal including noise is defined as

$$\begin{matrix}{S}_{*}^{′} = \frac{1}{T} {\int }_{0}^{T} {[ x ( t ) ]}^{2} ⅆ t \\ = \frac{1}{T} {\int }_{0}^{T} {[ {x}_{o} ( t ) + n ( t ) ]}^{2} ⅆ t \\ = \frac{1}{T} {\int }_{0}^{T} {[ {x}_{0} ( t ) ]}^{2} ⅆ t + \frac{1}{T} {\int }_{0}^{T} {[ n ( t ) ]}^{2} ⅆ t + \frac{2}{T} {\int }_{0}^{T} [ {x}_{0} ( t ) \cdot n ( t ) ] ⅆ t .\end{matrix} \qquad ( A .1 )$$

Using equations (3) and (4), we get

$${S}_{*}^{′} = S + {N}^{′} + \frac{2}{T} {\int }_{0}^{T} [ {x}_{o} ( t ) \cdot n ( t ) ] ⅆ t . \qquad ( A .2 )$$

Shannon assumed statistical independence of xₒ(t) and n(t), which made the last term of equation (A.2) vanish. In this article, we will remove this restriction, allowing for forms of noise

n(t)=−Kxₒ(t), (0≦K≦1) (A.3)

that can extinguish the signal, such that

x(t)=xₒ(t)+n(t)=(1−K)xₒ(t)≦xₒ(t) (A.4)

Here the amplitude (1−K) of x(t) diminishes with increasing noise: this can affect the signal power significantly. With the values just derived,

$$\frac{{S}_{*}^{′}}{{N}^{′}} = \frac{{( 1 - K )}^{2} \frac{1}{T} {\int }_{0}^{T} {[ {x}_{0} ( t ) ]}^{2} ⅆ t}{{K}^{2} \frac{1}{T} {\int }_{0}^{T} {[ {x}_{0} ( t ) ]}^{2} ⅆ t} = {( 1 - \frac{1}{K} )}^{2} \qquad ( A .5 )$$

can be less than unity, and the channel capacity can have negative values: as noise power proportional to K² increases, the output power proportional to (1−K)² decreases.

We claim:

1. A method of modeling a mechanical system comprising a plurality of physical components, comprising:
preparing a model of a mechanical system in which at least a portion of the physical components of the mechanical system are individually modeled, wherein the model is configured to output data representative of the condition of the mechanical system in response to an input of operating conditions for the mechanical system;
monitoring the condition of the mechanical system in response to predetermined operating conditions during use;
modifying the model such that the outputted data of the model in response to the predetermined operating conditions is representative of the condition of the mechanical system in response to the predetermined operating conditions.

2. The method of claim 1; further comprising predicting a failure time of the mechanical system using the modified model.

3. The method of claim 1, wherein all the physical components of the mechanical system are individually modeled.

4. The method of claim 1, wherein a possible fault for each of the individually modeled physical components are incorporated into the model.

5. The method of claim 1, wherein a potential failure for each of the individually modeled physical components are incorporated into the model.

6. The method of claim 1, wherein a plurality of possible failures for the individually modeled physical components may interact, rendering failures not specifically associated with any single component, but arising from interactions between components.

7. The method of claim 1, wherein the condition of the modeled mechanical system is represented within the model as noise.

8. The method of claim 1, wherein the condition of the modeled mechanical system is represented within the model as noise, and wherein the condition of the modeled mechanical system is determined by calculating a signal to noise ratio for the model.

9. The method of claim 1, further comprising:
calculating the channel capacity of the modeled mechanical system, wherein the channel capacity is representative of the design of the system and the present condition of the mechanical system;
calculating a rate of information for a predetermined job to be performed by the mechanical system, wherein the rate of information is representative of the speed, loads, complexity and desired accuracy of the job; and
comparing the rate of information to the channel capacity, wherein if the rate of information is less than or equal to the channel capacity the model will output data indicating that the mechanical system is capable of performing the job at the appropriate speed, load, and accuracy.

10. A computer implemented method of modeling a mechanical system comprising a plurality of physical components, the method comprising:
preparing a model of a mechanical system in which at least a portion of the physical components of the mechanical system are individually modeled, wherein the model is configured to output data representative of the condition of the mechanical system in response to an input of operating conditions for the mechanical system;
monitoring the condition of the mechanical system in response to predetermined operating conditions during use;
modifying the model such that the outputted data of the model in response to the predetermined operating conditions is representative of the condition of the mechanical system in response to the predetermined operating conditions.

11. A carrier medium comprising computer instructions, wherein the program instructions are computer-executable to implement a method of modeling a mechanical system comprising a plurality of physical components, the method comprising:
preparing a model of a mechanical system in which at least a portion of the physical components of the mechanical system are individually modeled, wherein the model is configured to output data representative of the condition of the mechanical system in response to an input of operating conditions for the mechanical system;
monitoring the condition of the mechanical system in response to predetermined operating conditions during use;
modifying the model such that the outputted data of the model in response to the predetermined operating conditions is representative of the condition of the mechanical system in response to the predetermined operating conditions.

12. A method for diagnosing a state of a system, the method comprising:
measuring a signal from the system;
comparing the signal from the system and an expected signal to determine a noise signal associated with the signal from the system;
determining a signal strength associated with the signal from the system;
determining a rate of information, the rate of information associated with a desired operability of the system;
determining a channel capacity from the noise signal and the signal strength, the channel capacity being a function of a frequency spectrum of the signal;
comparing the rate of information to the channel capacity to diagnosis the state of the system.

13. The method of claim 12 wherein the expected signal is a signal measured from an exemplary system operating in a known state.

14. The method of claim 12 wherein the expected signal is the output of a model.

15. The method of claim 14 wherein the output of the model is adapted to approximate the measured signal.

16. The method of claim 12, the method further comprising:
repeating the steps of the method over time to determine a set of diagnoses.
determining a prognosis of the system from the set of diagnoses.
